(19) United States
(12) Patent Application Publication
(10) Pub. No.: US 2026/0330581 A1
(43) Pub. Date: Oct. 22, 2026

(54) METHODS, SYSTEMS, AND STORAGE MEDIA FOR ENGINEERING SAFETY RISK MANAGEMENT

(71) Applicant: YIZHI TECHNOLOGY (CHENGDU) CO., LTD., Chengdu (CN)

(72) Inventors: Junjie LIU, Chengdu (CN); Guanglin DING, Chengdu (CN)

(73) Assignee: YIZHI TECHNOLOGY (CHENGDU) CO., LTD., Chengdu (CN)

(21) Appl. No.: 19/674,059

(22) Filed: May 11, 2026

Related U.S. Application Data
(63) Continuation of application No. PCT/CN2025/135843, filed on Nov. 18, 2025.

(30) Foreign Application Priority Data
Nov. 19, 2024 (CN) 202411650069.9
May 19, 2025 (CN) 202510639106.4

(51) Int. Cl. G06Q 50/26; G06Q 10/0635; G06Q 50/08

(52) U.S. Cl. CPC G06Q 50/265; G06Q 10/0635; G06Q 50/08

(57) ABSTRACT

The present disclosure provides a method for engineering safety risk management. The method includes obtaining historical construction data and constructing a safety risk database based on the historical construction data. The historical construction data includes a plurality of completed historical minimum production units and data related to historical accidents corresponding to each of the plurality of completed historical minimum production units. The method further includes determining safety risk data of a current construction project based on data collected from the current construction project and the safety risk database.

### CROSS-REFERENCE TO RELATED APPLICATIONS

This application is a continuation of International Patent Application No. PCT/CN2025/135843, filed on Nov. 18, 2025, which claims priority to Chinese Patent Application No. 202411650069.9, filed on Nov. 19, 2024, and Chinese Patent Application No. 202510639106.4, filed on May 19, 2025, the entire contents of each of which are hereby incorporated herein by reference.

### TECHNICAL FIELD

The present disclosure relates to the field of engineering safety management, and in particular, to methods, systems, and storage media for engineering safety risk management.

### BACKGROUND

With the continuous development of the construction industry and the constant improvement of engineering technology complexity, engineering safety risk management has become a core link for ensuring the smooth progress of engineering projects and the safety of personnel. Traditional safety management methods mainly rely on manual monitoring and regular inspections, and have many limitations, for example, being limited by personnel experience and subjective judgment, therefore, it is difficult to identify and assess risks systematically and accurately, and risks are prone to being omitted due to human negligence. As another example, in the face of complex construction projects with large scale, multiple types of work, and multiple stages, traditional methods are difficult to fully cover various dynamic risks, with poor universality and delayed response. As a further example, it is impossible to systematically integrate multiple types of risk factors, difficult to establish a clear causal relationship between risks and accidents, lacks an efficient and intelligent risk identification and warning mechanism, and has insufficient decision support.

Therefore, it is necessary to provide methods, systems, and storage media for engineering safety risk management to accurately and comprehensively realize the identification and analysis of risk factors affecting engineering safety, thereby conducting effective risk control and management.

### SUMMARY

One or more embodiments of the present disclosure provide a method for engineering safety risk management. The method includes obtaining historical construction data and constructing a safety risk database based on the historical construction data. The historical construction data includes a plurality of completed historical minimum production units and data related to historical accidents corresponding to each of the plurality of completed historical minimum production units. The method further includes determining safety risk data of a current construction project based on data collected from the current construction project and the safety risk database.

One or more embodiments of the present disclosure provide a method for engineering safety risk management. The method includes obtaining historical construction data, and determining, based on the historical construction data, first risk correlation information between a plurality of internal attributes of the each of the plurality of the completed historical minimum production units as well as a combination of the plurality of internal attributes, and the quality and safety events. The historical construction data includes a plurality of completed historical minimum production units and quality and safety events corresponding to each of the plurality of completed historical minimum production units. The plurality of internal attributes include at least one of a task item attribute, a personnel attribute, or a regional attribute. The method further includes determining a plurality of current minimum production units of a current construction project and current internal attributes of each of the plurality of current minimum production units; and determining, based on the current internal attributes and the first risk correlation information, one or more risk points of the plurality of current minimum production units and a risk probability corresponding to each of the one or more risk points. The each of the one or more risk points corresponds to one quality and safety event.

One or more embodiments of the present disclosure provide a method for engineering safety risk management. The method includes determining a target vector based on on-site engineering collected data, determining warning information related to an engineering safety risk based on the target vector and a safety risk model, and sending the warning information to a user. The target vector at least includes an on-site engineering characteristic element and an on-site risk characteristic element.

One or more embodiments of the present disclosure provide a system for engineering safety risk management, comprising at least one processor and at least one storage device, wherein the at least one storage device stores computer instructions, and the at least one processor executes the computer instructions to perform the method in the embodiments of the present disclosure.

One or more embodiments of the present disclosure provide a computer-readable storage medium, wherein the storage medium stores computer instructions, and when a computer reads the computer instructions in the storage medium, the computer performs the method in the embodiments of the present disclosure.

### BRIEF DESCRIPTION OF THE DRAWINGS

The present disclosure is further described by way of exemplary embodiments, which are described in detail with reference to the accompanying drawings. These embodiments are non-limiting, wherein identical numerals denote identical structures, and wherein:

FIG. 1 is a schematic diagram illustrating an exemplary engineering safety risk management system according to some embodiments of the present disclosure;

FIG. 2 is a flowchart illustrating an exemplary process for engineering safety risk management according to some embodiments of the present disclosure;

FIG. 3 is a flowchart illustrating an exemplary process for constructing a safety risk database according to some embodiments of the present disclosure;

FIG. 4 is a schematic diagram illustrating exemplary risk levels according to some embodiments of the present disclosure;

FIG. 5 is a flowchart illustrating an exemplary process for generating a risk display icon according to some embodiments of the present disclosure;

FIG. 6 is a schematic diagram illustrating an exemplary general layout drawing according to some embodiments of the present disclosure;

FIG. 7 is a schematic diagram illustrating an exemplary project display model according to some embodiments of the present disclosure;

FIG. 8A is a flowchart illustrating an exemplary process for engineering safety risk management according to some embodiments of the present disclosure;

FIG. 8B is a flowchart illustrating an exemplary process for constructing a safety risk model according to some embodiments of the present disclosure;

FIG. 9 is a schematic diagram illustrating an exemplary risk characteristic tree according to some embodiments of the present disclosure;

FIG. 10 is a schematic diagram illustrating an exemplary safety risk model according to some embodiments of the present disclosure;

FIG. 11 is a flowchart illustrating an exemplary process for determining a correlation relationship according to some embodiments of the present disclosure;

FIG. 12A is a schematic diagram illustrating an exemplary accident vector according to some embodiments of the present disclosure;

FIG. 12B is a schematic diagram illustrating classifying accident vectors according to some embodiments of the present disclosure;

FIG. 13 is a flowchart illustrating an exemplary process for determining a correlation relationship according to some embodiments of the present disclosure;

FIG. 14 is a flowchart illustrating an exemplary process for determining a key risk characteristic element according to some embodiments of the present disclosure;

FIG. 15 is a block diagram illustrating an exemplary engineering safety risk management system according to some embodiments of the present disclosure;

FIG. 16 is a block diagram illustrating an exemplary engineering safety risk management system according to some embodiments of the present disclosure; and

FIG. 17 is a block diagram illustrating an exemplary engineering safety risk management system according to some embodiments of the present disclosure.

### DETAILED DESCRIPTION

To more clearly illustrate the technical solutions of the embodiments of the present disclosure, a brief introduction will be given below to the accompanying drawings required for describing the embodiments. Obviously, the drawings described below are only some examples or embodiments of the present disclosure. For those of ordinary skill in the art, without creative efforts, the present disclosure can be applied to other similar scenarios based on these drawings. Unless obvious from the language context or otherwise stated, the same reference numerals in the drawings represent the same structures or operations.

It should be understood that the terms “system”, “apparatus”, “unit”, and/or “module” used herein are intended as a method for distinguishing different components, elements, parts, sections, or assemblies at different levels. However, if other terms can achieve the same purpose, such terms may be replaced by other terms.

As shown in the present disclosure and the claims, unless the context clearly indicates otherwise, the terms “a”, “an”, “one”, and/or “the” do not specifically refer to the singular and may also include the plural. Generally speaking, the terms “comprise” and “include” only suggest that the clearly identified steps and elements are included, and such steps and elements do not constitute an exclusive list, and the method or apparatus may also include other steps or elements.

Flowcharts are used in the present disclosure to illustrate the operations performed by the system according to the embodiments of the present disclosure. It should be understood that the preceding or subsequent operations are not necessarily performed precisely in sequence. On the contrary, the operations may be processed in reverse order or simultaneously. Meanwhile, other operations may be added to these processes, or one or more operations may be removed from these processes.

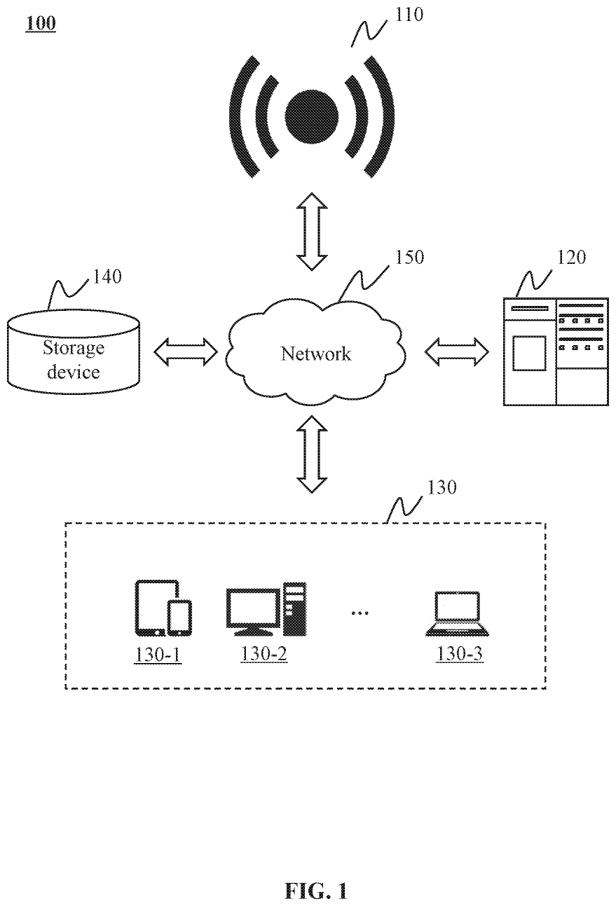

FIG. 1 is a schematic diagram illustrating an exemplary engineering safety risk management system according to some embodiments of the present disclosure. As illustrated in FIG. 1, an engineering safety risk management system 100 may include a data collection device 110, a server 120, a user terminal 130, a storage device 140, and a network 150.

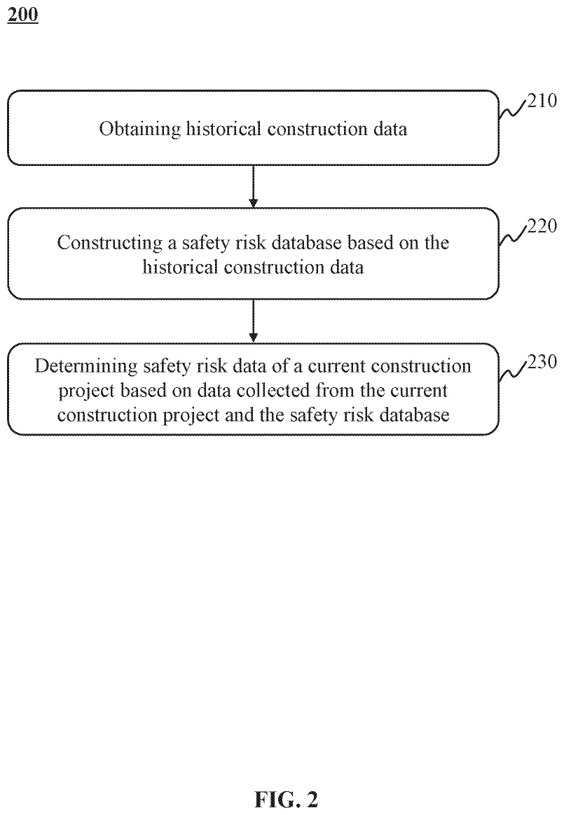

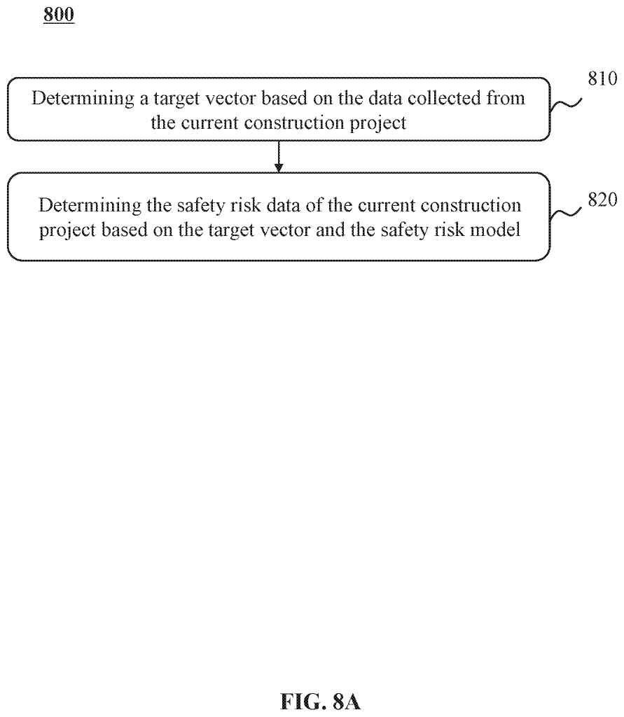

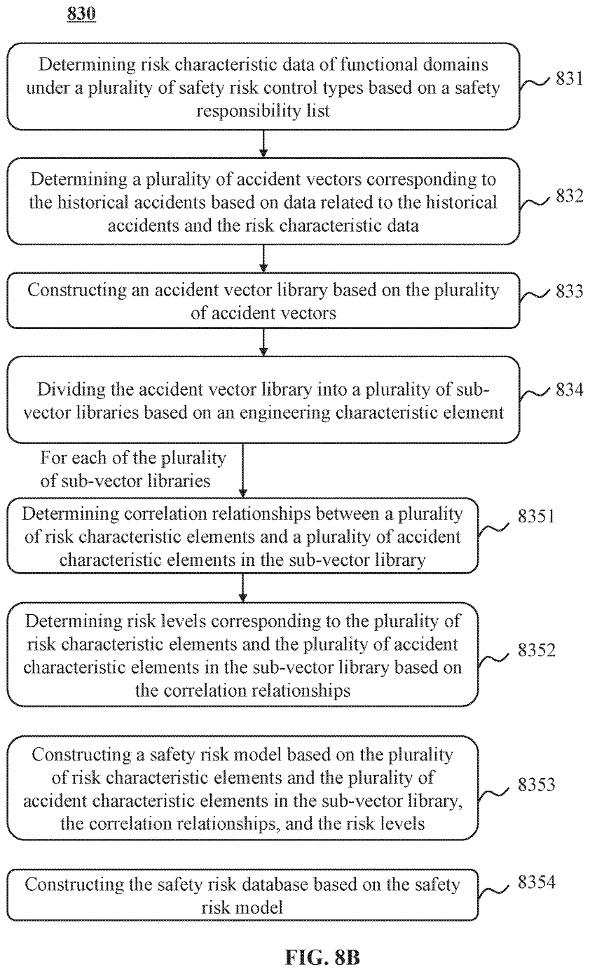

The data collection device 110 refers to a device configured to collect engineering data. The engineering data refers to data and information related to an engineering activity. For example, the engineering data may include data collected from a current construction project, or the like. The engineering activity may include one or more of a construction, a reconstruction, a maintenance, and a demolition of a building, a railway, or the like. More descriptions of the data collected from the current construction project may be found elsewhere in the present disclosure (e.g., FIG. 2, FIG. 8A, and the descriptions thereof). In some embodiments, the data collection device 110 may include a measuring instrument, a sensor, or the like. In some embodiments, the engineering data collected from the data collection device 110 may be transmitted to the server 120, the user terminal 130, the storage device 140, etc., via the network 150 to realize data exchange and communication. In some embodiments, a user may be located at an engineering site and collect on-site engineering data through the data collection device 110. The engineering site refers to a site for conducting construction and other related engineering activities. It should be noted that the above description of the engineering activity and the engineering site is intended to be illustrative, and not to limit the scope of the present disclosure.

The server 120 is configured to manage resources and process data and/or information of at least one component in the engineering safety risk management system 100 or an external data source. In some embodiments, the server 120 may be a single server or a server group. The server group may be centralized or distributed, and may be dedicated or provide services simultaneously with other devices or systems. In some embodiments, the server 120 may be regional or remote. In some embodiments, the server 120 may be implemented on a cloud platform or provided in a virtual manner.

In some embodiments, the server 120 may include a processor. The processor may be configured to process information and/or data related to the engineering safety risk management system 100. In some embodiments, the processor may process data, information, and/or processing results obtained from other devices or system components, and execute program instructions based on the data, information, and/or processing results to perform one or more functions described in the present disclosure. For example, the processor may obtain historical construction data and construct a safety risk database based on the historical construction data. As another example, the processor may determine a target vector based on on-site engineering collected data. As a further example, the processor may determine warning information related to an engineering safety risk based on the target vector and a safety risk model, and send the warning information to a user via the user terminal 130. More descriptions may be found in the related descriptions below.

In some embodiments, the processor may include one or more sub-processing devices (e.g., a single-core processing device or a multi-core processing device). For example, the processor may include a central processing unit (CPU), a graphics processing unit (GPU), a reduced instruction set computer (RISC), a microprocessor, or the like, or any combination thereof.

The user terminal 130 refers to one or more terminal devices or software used by a user. The user refers to a user or manager of a method and system for engineering safety risk management. For example, a contractor, a safety officer, a manager, construction personnel, or the like.

In some embodiments, a user may interact with other components (e.g., the server 120, etc.) in the engineering safety risk management system 100 via the user terminal 130 through the network 150. For example, the server 120 may send safety risk data of the current construction project, a risk display icon, warning information related to the engineering safety risk, etc., to the user terminal 130 via the network 150. As another example, a user may interact with the server 120 based on the user terminal 130 to obtain the historical construction data, or the like.

In some embodiments, the user terminal 130 may include a mobile device 130-1, a computer 130-2, a laptop computer 130-3, or the like, or any combination thereof. In some embodiments, the user terminal 130 may also include a virtual reality device, such as a VR (Virtual Reality) device, an AR (Augmented Reality) device, or the like. In some embodiments, the user terminal 130 may also include a display screen, a loudspeaker, etc., disposed at the engineering site to display the risk display icon, warning information, etc., to the user at the engineering site.

The storage device 140 is configured to store data, instructions, and/or any other information. The storage device 140 may include one or more storage components, each of which may be an independent device or a part of another device.

In some embodiments, the storage device 140 may include a random access memory (RAM), a read-only memory (ROM), a removable storage device, or the like, or any combination thereof. In some embodiments, the storage device 140 may be connected to the network 150 to realize communication with one or more components in the engineering safety risk management system 100. In some embodiments, the storage device 140 may be a part of the server 120.

The network 150 may include any suitable network that can facilitate the exchange of information and/or data for the engineering safety risk management system 100. In some embodiments, one or more components (e.g., the data collection device 110, the server 120, the user terminal 130, the storage device 140, etc.) of the engineering safety risk management system 100 may exchange information and/or data with one or more other components of the engineering safety risk management system 100 via the network 150. In some embodiments, the network 150 may include any one or more of wired networks or wireless networks in any form. In some embodiments, the network 150 may include one or more network access points.

It should be noted that the engineering safety risk management system 100 is provided merely for illustrative purposes and is not intended to limit the scope of the present disclosure. For those of ordinary skill in the art, various modifications or changes may be made according to the description of the present disclosure. For example, the engineering safety risk management system 100 may be implemented on other devices to achieve similar or different functions. However, such changes and modifications do not depart from the scope of the present disclosure.

FIG. 2 is a flowchart illustrating an exemplary process for engineering safety risk management according to some embodiments of the present disclosure. As illustrated in FIG. 2, a process 200 may include the following steps. In some embodiments, the process 200 may be performed by an engineering safety risk management system (e.g., the server 120 of the engineering safety risk management system 100, modules of an engineering safety risk management system 1500).

Step 210, obtaining historical construction data. In some embodiments, step 210 may be performed by an obtaining module 1510.

The historical construction data refers to various data and records generated in completed construction projects. For example, the historical construction data may include a construction task, a construction area, construction personnel, a construction period, a weather condition, etc.

In some embodiments, the historical construction data includes a plurality of completed historical minimum production units and data related to historical accident(s) corresponding to each of the plurality of completed historical minimum production units.

The minimum production unit refers to a most basic work group or work unit in a construction project that is capable of independently completing a specific construction task or process. For example, the minimum production unit may include a work unit for rebar tying, concrete pouring, formwork installation, electrical wiring, or the like. The completed historical minimum production unit refers to a minimum production unit in a completed/conducted construction project.

The data related to the historical accident(s) (also referred to as quality and safety event(s), it is understandable that when a quality and safety event has occurred, the quality and safety event may be regarded as a historical accident) refers to data related to an accident or problem in engineering quality or safety. For example, the data related to the historical accident(s) may include an accident time, an accident location, an accident cause, an accident casualty, an event classification, a hazard degree, etc.

In some embodiments, there are corresponding relationships between the completed historical minimum production units and the data related to the historical accidents. For example, a historical accident corresponding to a concrete pouring work unit may include substandard concrete strength, and a quality and safety event corresponding to an exterior wall construction unit includes a fall from height, or the like. In some embodiments, one completed historical minimum production unit may correspond to a plurality of historical accidents. For example, an electrical wiring work unit may correspond to historical accidents including a line short-circuit accident, an electric shock safety accident, etc. In some embodiments, one historical accident may also correspond to a plurality of completed historical minimum production units. For example, a fall from height accident in the historical accident may correspond to minimum production units including a scaffold erection and dismantling unit, an exterior wall construction unit, or the like.

In some embodiments, the historical construction data may be pre-stored in the storage device 140 in a form of a diagram, a table, a vector, or the like. The processor may obtain the historical construction data by reading from the storage device 140. In some embodiments, the historical construction data may be obtained by one or more of the following manners. For example, during a process of a historical construction, data such as a construction task, a construction areas, construction personnel, a construction period, a weather condition in the process of the historical construction may be collected as historical construction data in manners of a manual collection, an Internet of Things device (e.g., a temperature and humidity sensor, an anemometer and a wind vane, a camera device, etc.), an unmanned aerial vehicle and remote sensing technology, etc., and the historical construction data may be transmitted to the storage device 140 and/or a cloud platform via an industrial router, an Internet of Things gateway, etc., and the processor may obtain the historical construction data by accessing the storage device 140 and/or the cloud platform. In some embodiments, the processor may also obtain the historical construction data by parsing relevant materials (e.g., a design drawing, a safety management material, a construction process record, etc.) of a historical construction project. Exemplary parsing manners may include one or more of a machine vision technology, an optical character recognition technology, a natural language processing, a text mining, or the like. In some embodiments, the processor may also obtain the historical construction data through a third-party information source (e.g., the Internet, a commercial database, a data provider, etc.).

Step 220, constructing a safety risk database based on the historical construction data. In some embodiments, Step 220 may be performed by a construction module 1520.

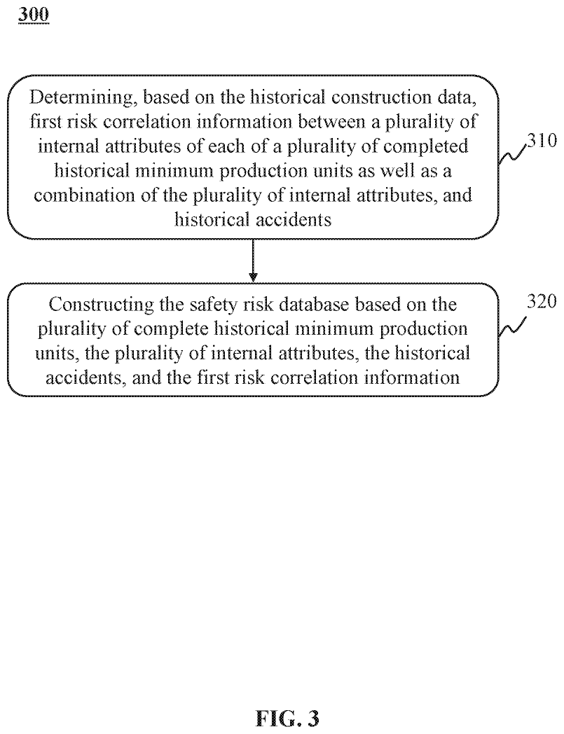

The safety risk database refers to a core data set for storing, managing, and analyzing engineering safety risk information. In some embodiments, the safety risk database may include first risk correlation information between each internal attribute of a plurality of internal attributes of a completed historical minimum production unit as well as each combination of the plurality of internal attributes, and each quality and safety event. In some embodiments, the safety risk database may include a safety risk model. More descriptions of the safety risk database may be found elsewhere in the present disclosure (e.g., FIG. 3, FIG. 8B, and the descriptions thereof).

In some embodiments, the processor may determine the first risk correlation information between a plurality of internal attributes of each of the plurality of completed historical minimum production units as well as a combination of the plurality of internal attributes, and the historical accident(s) based on the historical construction data; and construct the safety risk database based on the plurality of completed historical minimum production units, the plurality of internal attributes, the historical accident(s), and the first risk correlation information. More descriptions of constructing the safety risk database may be found elsewhere in the present disclosure (e.g., FIG. 3 and the description thereof).

In some embodiments, the processor may determine risk characteristic data of functional domains under a plurality of safety risk control types based on a safety responsibility list; determine a plurality of accident vectors corresponding to the historical accidents based on data related to the historical accidents and the risk characteristic data; construct an accident vector library based on the plurality of accident vectors; divide the accident vector library into a plurality of sub-vector libraries based on an engineering characteristic element; for each of the plurality of sub-vector libraries, determine correlation relationships between a plurality of risk characteristic elements and a plurality of accident characteristic elements in the sub-vector library; determine risk levels corresponding to the plurality of risk characteristic elements and the plurality of accident characteristic elements in the sub-vector library based on the correlation relationship; construct a safety risk model based on the plurality of risk characteristic elements and the plurality of accident characteristic elements in the sub-vector library, the correlation relationships, and the risk levels; and construct the safety risk database based on the safety risk model. More descriptions of constructing the safety risk database may be found elsewhere in the present disclosure (e.g., FIG. 8B and the description thereof).

Step 230, determining safety risk data of a current construction project based on data collected from the current construction project and the safety risk database. In some embodiments, Step 230 may be performed by a determination module 1530.

The current construction project refers to a construction engineering task requiring safety risk management. For example, the current construction project may include a residential construction project, a commercial construction project, a road construction project, etc. The data collected from the current construction project may include various construction data such as a construction drawing, a construction contract list, engineering design and planning data, construction management data, on-site engineering characteristic data, on-site risk characteristic data, or the like. The on-site engineering characteristic data refers to engineering characteristic data collected at an engineering site. Engineering characteristic data refers to data information related to engineering, such as an engineering category (e.g., transportation engineering, building construction engineering, water conservancy engineering, etc.) and an engineering scale (e.g., engineering with a volume of 0-100,000 cubic meters, 100,000-200,000 cubic meters, etc.). More descriptions of the risk characteristic data may be found in the related descriptions above and below (e.g., Step 831). It is understandable that safety risk management may include quality and safety control, which refers to evaluating and analyzing a construction quality and safety of a construction project to improve engineering quality and reduce safety risks.

In some embodiments, the processor may obtain the data collected from the current construction project through one or more manners. Fr example, the processor may directly obtain the data collected from the current construction project through a data collection device (e.g., the data collection device 110). As another example, the processor may determine the data collected from the current construction project based on engineering data recorded in a storage device internal or external to the engineering safety risk management system 100.

The safety risk data refers to an information set that characterizes a safety status of a current project, predicts a potential accident, and guides a risk control action. In some embodiments, the safety risk data may include one or more risk points of a current minimum production unit and a risk probability corresponding to each of the one or more risk points. More descriptions of the safety risk data may be found elsewhere in the present disclosure (e.g., FIG. 3, FIG. 8A, and the descriptions thereof).

In some embodiments, the processor may determine a plurality of current minimum production units of the current construction project and current internal attributes of each of the plurality of current minimum production units based on data collected from the current construction project; and determine one or more risk points of the plurality of current minimum production units and a risk probability corresponding to each of the one or more risk points based on the current internal attributes and the first risk correlation information. More descriptions of determining the safety risk data of the current construction project may be found elsewhere in the present disclosure (e.g., FIG. 3 and the description thereof).

In some embodiments, the processor may determine a target vector based on the data collected from the current construction project, the target vector at least including an on-site engineering characteristic element and an on-site risk characteristic element; and determine the safety risk data of the current construction project based on the target vector and the safety risk model. More descriptions of determining the safety risk data of the current construction project may be found elsewhere in the present disclosure (e.g., FIG. 8A and the description thereof).

In some embodiments of the present disclosure, by obtaining historical construction data, constructing a safety risk database; and determining safety risk data of a current construction project based on data collected from the current construction project and the safety risk database, discrete and easily lost historical data and accident experience can be integrated into an intelligent safety risk database. The safety risk database can be used to identify potential risks of the current project and quantify their occurrence probabilities, thereby realizing pre-warning of safety risks, reducing subjective errors of manual judgment, making risk assessment results more objective, accurate, and reliable, improving the overall safety management level, and safeguarding safety of personnel and smooth progress of the engineering.

FIG. 3 is a flowchart illustrating an exemplary process for constructing a safety risk database according to some embodiments of the present disclosure. As illustrated in FIG. 3, a process 300 may include the following steps. In some embodiments, the process 300 may be performed by the engineering safety risk management system (e.g., the server 120 of the engineering safety risk management system 100, modules of the engineering safety risk management system 1500).

Step 310, determining first risk correlation information between a plurality of internal attributes of each of the plurality of completed historical minimum production units as well as a combination of the plurality of internal attributes, and the historical accident(s) based on the historical construction data. In some embodiments, Step 310 may be performed by the construction module 1520. More descriptions of the historical construction data, the completed historical minimum production unit, and the historical accident(s) may be found elsewhere in the present disclosure (e.g., FIG. 2 and the descriptions thereof).

An internal attribute refers to data and/or information related to a construction process of a construction project. In some embodiments, the internal attribute includes at least one of a task item attribute, a personnel attribute, and a regional attribute.

The task item attribute refers to data and/or information related to a construction task. For example, the task item attribute may include a task number, a task name (e.g., “formwork installation”, “concrete pouring”, etc.), or the like.

The personnel attribute refers to human resource data and/or information of participants in a construction project. For example, the personnel attribute may include a personnel number, a name, contact information, a position/trade, a safety training record (e.g., a status of participating in safety education or training, etc.), or the like.

The regional attribute refers to data and/or information of different regions or areas of a construction site. For example, the regional attribute may include a region number, a region name (e.g., “exterior wall”, “underground garage”, etc.), a region location (a specific geographic or building location, which may be represented in manners of a text, a plan view, a coordinate, etc.).

In some embodiments, the internal attribute may also include various other attributes. For example, the internal attribute may also include a construction period attribute, a construction cost attribute, a construction material attribute, or the like.

In some embodiments, the processor may determine the plurality of internal attributes of the each of the plurality of completed historical minimum production units based on the historical construction data. For example, the processor may parse the historical construction data in manners of statistical analysis, data mining and text analysis, a machine learning model, etc., to obtain the internal attributes corresponding to each completed historical minimum production unit.

The combination of the plurality of internal attributes is a result obtained by freely combining the plurality of internal attributes of each completed historical minimum production unit. Merely by way of example, if the completed historical minimum production unit includes three internal attributes A, B, and C, combining them may obtain four combinations of the internal attributes, i.e., AB, AC, BC, and ABC.

The first risk correlation information refers to a correlation between at least one of the internal attributes or the combination of the internal attributes of the completed historical minimum production unit, and a risk of occurrence of a quality and safety event (or an accident). The first risk correlation information may indicate the risk of occurrence of the quality and safety event by a probability, where a higher probability means a greater risk.

In some embodiments, the processor may process the historical construction data through a machine learning model, a preset algorithm, or other manners to determine the first risk correlation information between the plurality of internal attributes of each of the plurality of completed historical minimum production units as well as the combination of the plurality of internal attributes, and the historical accident(s).

In some embodiments, the processor may determine a first set and a second set; determine historical accidents corresponding to all completed historical minimum production units in the first set and the second set; and determine the first risk correlation information based on a count of completed historical minimum production units and a count of historical accidents in the first set, as well as a count of completed historical minimum production units and a count of historical accidents in the second set.

The first set consists of one or more completed historical minimum production units to which the internal attributes belong. For example, if an internal attribute A appears in 100 completed historical minimum production units in total and an internal attribute B appears in 70 completed historical minimum production units in total, the 100 completed historical minimum production units to which the internal attribute A belongs and the 70 completed historical minimum production units to which the internal attribute B belongs form the first set.

The second set consists of one or more completed historical minimum production units to which the combination of the internal attributes belongs. For example, if a combination AB of the internal attributes A and B appears in 110 completed historical minimum production units in total and a combination BC of the internal attributes B and C appears in 80 completed historical minimum production units in total, the 110 completed historical minimum production units to which the combination AB of the internal attributes A and B belongs and the 80 completed historical minimum production units to which the combination BC of the internal attributes B and C belongs form the second set.

In some embodiments, the processor may determine the historical accidents in the first set and the historical accidents in the second set respectively. For example, the processor may determine, in the first set and the second set respectively, a count of historical accidents that have occurred corresponding to the completed historical minimum production unit, as well as data related to the historical accidents such as accident time, accident location, accident cause, accident casualty, event classification, hazard degree, or the like.

In some embodiments, the processor may determine the first risk correlation information by a calculation based on the count of completed historical minimum production units and the count of historical accidents in the first set, as well as the count of completed historical minimum production units and the count of historical accidents in the second set.

For example, among the 100 completed historical minimum production units to which the internal attribute A belongs in the first set, a historical accident W₁ occurs 10 times and a historical accident W₂ occurs 30 times, then a first risk correlation information between the internal attribute A and the historical accident W₁ is 10%, and a first risk correlation information between the internal attribute A and the historical accident W₂ is 30%. As another example, among the 80 completed historical minimum production units to which the combination BC of the internal attributes B and C belongs in the second set, a historical accident W₁ occurs 30 times and a historical accident W₃ occurs 40 times, then a first risk correlation information between the combination BC of the internal attributes B and C and the historical accident W₁ is 37.5%, and the first risk correlation information between the combination BC of the internal attributes B and C and the historical accident W₃ is 50%. Similarly, the processor may determine the first risk correlation information between all the internal attributes as well as combinations of the internal attributes, and all the historical accidents in the first set and the second set.

It should be noted that in some embodiments, an accidental error may be caused when the count of the internal attributes (or the combination of the internal attributes) is too small. For example, an internal attribute D belongs to only 1 completed historical minimum production unit, and the completed historical minimum production unit to which the internal attribute D belongs happens to have a historical accident W₁; obviously, in this case, the first risk correlation information between the internal attribute D and the historical accident W₁ is not necessarily 100%, which is merely an accidental error caused by an insufficient sample size. In some embodiments, when determining the first risk correlation information, the processor may only determine the first risk correlation information between an internal attribute (or a combination of the internal attributes) to which a count of historical production units exceeding a threshold belongs and a historical accident, so as to reduce the accidental error and improve an accuracy of the first risk correlation information.

Step 320, constructing a safety risk database based on the plurality of completed historical minimum production units, the plurality of internal attributes, the historical accident(s), and the first risk correlation information. In some embodiments, Step 320 may be performed by the construction module 1520.

In some embodiments, the processor may organize and construct the safety risk database based on the plurality of completed historical minimum production units, the plurality of internal attributes, the historical accident(s), and the first risk correlation information. In the safety risk database, a corresponding relationship among the plurality of completed historical minimum production units, the plurality of internal attributes, the historical accident(s), and the first risk correlation information may be represented in various forms such as a tree, a graph, a table, a vector, or the like.

In some embodiments, the processor may determine a plurality of current minimum production units of the current construction project and current internal attributes of each of the plurality of current minimum production units based on the data collected from the current construction project.

The current minimum production unit refers to a minimum production unit in the current construction project. The current internal attribute refers to an internal attribute of the current minimum production unit.

In some embodiments, the processor may determine the plurality of current minimum production units of the current construction project and the current internal attributes of the each of the plurality of current minimum production units in manners of statistical analysis, data mining and text analysis, a machine learning model, etc., based on construction data such as a construction design drawing and a construction contract list of the current construction project. Information such as a construction specification, a material, a dimension, a construction process, or the like may be marked in the construction design drawing. The construction contract list may stipulate information such as a construction task, a construction area, a performance object, a construction period, or the like.

In some embodiments, the processor may determine one or more risk points of the plurality of current minimum production units and a risk probability corresponding to each of the one or more risk points based on the current internal attributes and the first risk correlation information.

A risk point refers to a potential accident in a current minimum production unit. For example, if an accident W₁ may occur in a current minimum production unit P, the accident W₁ may be referred to as a risk point of the current minimum production unit P. In some embodiments, each risk point corresponds to one accident. The risk probability refers to a probability of an accident occurring in the current minimum production unit.

In some embodiments, the processor may determine one or more risk points of the plurality of current minimum production units and a risk probability corresponding to the each of the one or more risk points based on the current internal attributes and the first risk correlation information.

In some embodiments, the processor may determine the one or more risk points and a plurality of sub-risk probabilities of the each of the one or more risk points based on the current internal attributes, a combination of the current internal attributes, and the first risk correlation information; and determine the risk probability corresponding to the each of the one or more risk points based on the plurality of sub-risk probabilities of the each of the one or more risk points.

The combination of the current internal attributes refers to a result obtained by freely combining the current internal attributes. For example, for current internal attributes X, Y, and Z, four combinations of the current internal attributes, i.e., XY, XZ, YZ, and XYZ, can be obtained by freely combining them.

In some embodiments, the processor may match the current internal attributes and the combination of the current internal attributes with the internal attributes and/or the combinations of the internal attributes in the safety risk database; upon a successful match, take a historical accident with the first risk correlation information greater than a preset probability threshold (e.g., 1%) in the completed historical minimum production units as a risk point of the current minimum production unit (if the first risk correlation information is less than the preset probability threshold, it indicates a low occurrence probability, and it can be considered that no risk exists), and determine the first risk correlation information corresponding to the historical accident as the risk probability corresponding to the risk point.

The matching manner may be determined based on a type of the safety risk database. For example, if a safety risk database is a vector database, the matching manner may include that a distance (e.g., a cosine distance, an Euclidean distance, a Manhattan distance, a Chebyshev distance, etc.) between the current internal attributes and/or the combination of the current internal attributes and the internal attributes and/or the combinations of the internal attributes in the safety risk database is the smallest or meets a preset threshold, or the like.

In some embodiments, the same accident may correspond to a plurality of pieces of first risk correlation information, and the plurality of pieces of first risk correlation information may be referred to as sub-risk probabilities of the risk point corresponding to the accident. For example, a current minimum production unit P has three current internal attributes X, Y, and Z, which are respectively matched with internal attributes A, B, and C in the safety risk database; a first risk correlation information corresponding to the internal attribute A for the accident W₁ is 20%, a first risk correlation information corresponding to the internal attribute B for the accident W₁ is 30%, a first risk correlation information corresponding to the internal attribute C for the accident W₁ is 0, a first risk correlation information corresponding to a combination AB of the internal attributes A and B for the accident W₁ is 15%, etc.; then a plurality of sub-risk probabilities of the risk point corresponding to the accident W₁ for the current minimum production unit P are 20%, 30%, 15%, etc., respectively.

In some embodiments, the processor may sort the plurality of sub-risk probabilities of a risk point and determine a maximum sub-risk probability as the risk probability of the risk point.

In some embodiments of the present disclosure, by determining the first risk correlation information between the plurality of internal attributes of the each of the plurality of completed historical minimum production unit as well as the combination of the plurality of internal attributes, and the historical accident(s) based on the historical construction data; constructing the safety risk database based on the completed historical minimum production units, the plurality of internal attributes, the historical accident(s), and the first risk correlation information; determining the plurality of current minimum production units of the current construction project and the current internal attribute of the each of the plurality of current minimum production units based on the data collected from the current construction project; and determining the one or more risk points of the current minimum production units and the risk probability corresponding to the each of the one or more risk points based on the current internal attributes and the first risk correlation information, the historical construction data can be utilized to extract and quantify task characteristics, the processor can identify risk points based on the characteristics, and predict the accident occurrence probability of the current project, which facilitates tracing a root cause for overall engineering safety risk management and reduces subjective errors caused by manual judgment of safety risks.

In some embodiments, the minimum production unit further includes external attributes.

An external attribute refers to data and/or information that is not directly related to the construction process of the construction project but may affect accidents during the construction process. In some embodiments, the external attributes at least include an inspection attribute. The inspection attribute refers to an attribute related to project inspection in the construction project, such as an inspection count, an inspection object, an inspection standard, or the like. It is understandable that different inspection attributes have different impacts on an accident occurrence. For example, a higher inspection count and/or a stricter inspection standard means a lower probability of the accident occurrence. In some embodiments, the external attributes including the inspection attribute can further improve the accuracy of a predicted risk probability of the accident occurrence and achieve a better accident control effect.

In some embodiments, the external attributes may also include various other attributes such as weather, construction inspection, construction rectification, construction acceptance, or the like. The external attributes are prone to change. For example, the weather may change at any time. As another example, the inspection count, the construction rectification, and the construction acceptance may be different for different minimum production units.

In some embodiments, the processor may determine second risk correlation information between a plurality of external attributes of the each of the plurality of completed historical minimum production units as well as a plurality of combinations of the external attributes, and the historical accident(s) based on the historical construction data.

In some embodiments, a manner for obtaining the external attributes of the historical construction data is similar to the manner for obtaining the internal attributes, specific descriptions may be found in the related descriptions above (e.g., step 310).

The second risk correlation information refers to a correlation between the external attributes and/or the combination of the external attributes of a completed historical minimum production unit and a risk of an accident occurrence. The second risk correlation information may indicate the risk of the accident occurrence by a probability, where a higher probability means a greater risk.

In some embodiments, a manner for determining the second risk correlation information is similar to the manner for determining the first risk correlation information, specific descriptions may be found in the related descriptions above (e.g., step 310). In some embodiments, the processor may add data related to the external attributes, the combination of the external attributes, and the second risk correlation information to the safety risk database.

In some embodiments, in response to determining that a current minimum production unit of the current construction project is under construction, the processor may obtain current external attributes of the current minimum production unit.

The current external attributes refer to external attributes of the current minimum production unit.

In some embodiments, the current external attributes may be collected and obtained by a user (e.g., a manager), or automatically collected based on Internet of Things (IoT) devices, or the like.

In some embodiments, the current external attributes may change frequently. Therefore, during the construction process, the current external attributes may be collected periodically and updated.

In some embodiments, the processor may determine one or more risk points of the current minimum production unit and a risk probability corresponding to each of the one or more risk points based on the current internal attributes of the current minimum production unit, the current external attributes, the first risk correlation information, and the second risk correlation information.

For example, the processor may determine a corresponding first risk correlation information based on the current internal attributes of the current minimum production unit, determine an accident corresponding to the first risk correlation information as an internal risk point of the current minimum production unit, and determine the first risk correlation information as an internal risk probability corresponding to the current internal attributes of the current minimum production unit; determine a corresponding second risk correlation information based on the current external attributes of the current minimum production unit, determine an accident corresponding to the second risk correlation information as an external risk point of the current minimum production unit, and determine the second risk correlation information as an external risk probability corresponding to the current external attributes of the current minimum production unit. That is, the risk probability of the risk point includes the internal risk probability corresponding to the current internal attributes and the external risk probability corresponding to the current external attributes.

In some embodiments, when constructing the safety risk database, the processor may freely combine the internal attributes and the external attributes, and determine third risk correlation information according to a manner similar to the manner for determining the first risk correlation information in step 310. Further, the processor may also combine the current internal attributes and the current external attributes, and determine the one or more risk points and a risk probability corresponding to the each of the one or more risk points based on the third risk correlation information according to a manner similar to that in Step 320.

In some embodiments, the processor may determine the one or more risk points of the current minimum production unit and the risk probability corresponding to the each of the one or more risk points based on the current internal attributes of the current minimum production unit, the current external attributes of the current minimum production unit, the first risk correlation information, and the second risk correlation information through a machine learning model.

The machine learning model may include any one of a Neural Network (NN) model, a Deep Neural Network (DNN) model, a Graph Neural Network (GNN) model, or the like, or a combination thereof. An input of the machine learning model includes the current internal attributes and the current external attributes of the current minimum production unit, and an output includes one or more risk points of the current minimum production unit and a risk probability corresponding to the each of the one or more risk points. Training samples of the machine learning model include a large number of internal attributes (and/or combinations of internal attributes) and external attributes (and/or combinations of external attributes) in the historical construction data, and training labels include the first risk correlation information and the second risk correlation information.

In some embodiments, the attributes of the minimum production unit may also include a time attribute. In some embodiments, the time attribute may be represented as a construction progress node (or referred to as a construction stage, e.g., “the 5th day of foundation pit excavation”, “a main structure constructed to the 10th floor”, etc.) of the project progress.

In some embodiments, correspondingly, the aforementioned machine learning model may also be a model suitable for time series data analysis, such as a Long Short-Term Memory (LSTM) model, a Transformer model for time series, or the like. The input of the model includes the current internal attributes, the current external attributes, and the time attribute of the current minimum production unit. Through training, the model may learn a dynamic correlation between various attributes and risk points at different construction progress nodes.

In application, the processor may input the current construction progress node together with other attributes into the machine learning model. The machine learning model dynamically adjusts its internal parameters according to the time attribute, thereby preferentially outputting high-frequency risk points strongly correlated with the current construction stage. For example, when identifying that a project is in “a mid-stage of a main structure construction”, the machine learning model will increase weights of risks such as “formwork support instability” and “fall from high-altitude operation”, and reduce weights of risks in a foundation stage such as “foundation pit collapse”. This realizes “temporal dynamic adaptability” of model parameters during a risk warning process, and significantly improves a timeliness and accuracy of risk identification.

In some embodiments, the aforementioned machine learning model may further integrate a model interpretability algorithm, such as a Local Interpretable Model-agnostic Explanations (LIME) algorithm, a SHapley Additive exPlanations (SHAP) algorithm, or the like.

It is understandable that if the machine learning model only outputs risk points and risk probabilities, the construction personnel may find it difficult to understand causes of risks and convert output information into a specific and effective rectification action. By integrating the model interpretability algorithm, a risk cause explanation report may be generated for the output risk points (e.g., “a risk probability of concrete pouring is 40%, main reasons: \textcircled{1}personnel attribute-2 pouring errors of a team in the past 3 days; \textcircled{2}task item attribute-concrete initial setting time exceeds a standard time by 15 minutes, etc.). The report quantitatively displays a key cause leading to each risk point and its influence degree in a clear and readable form, enabling on-site personnel without a professional data analysis background to quickly understand a root cause of a risk, thereby lowering a technical threshold for using the system and improving an efficiency of risk control.

In some embodiments, as mentioned above, the current external attributes change greatly and need to be updated in real time. After the current external attributes are updated, the risk points and the risk probabilities corresponding to the risk points also need to be updated accordingly.

In some embodiments of the present disclosure, using internal attributes and external attributes can improve the accuracy of the determined risk points and risk probabilities, enabling targeted investigation and rectification of the risk points, thereby reducing the possibility of the accident occurrence. Meanwhile, when the external attributes of the construction project change, updating the risk points and their corresponding risk probabilities in a timely manner can further reduce the possibility of the accident occurrence.

In some embodiments, the processor may also obtain accidents occurring in each current minimum production unit during the construction process, and update the first risk correlation information and/or the second risk correlation information. For example, the processor may update the safety risk database by taking accidents that have occurred during the construction process and the corresponding internal attributes and external attributes as historical construction data.

In some embodiments of the present disclosure, by updating the safety risk database according to accidents that have occurred during the construction process, the risk points and risk probabilities can be adjusted according to specific construction conditions, which further reduces the probability of the accident occurrence and achieves a better quality and safety control effect.

It should be noted that when investigating and dealing with accidents, it is necessary to prioritize solving accidents with a higher urgency. However, different accidents have different risk probabilities and hazard degrees, and determining an accident based only on the risk probability or only on the hazard degree cannot meet the requirements. For example, a risk probability of worker abrasion is high and a hazard degree of the worker abrasion is low; a risk probability of worker falling is low and a hazard degree of the worker falling is high.

In some embodiments, the processor may determine fourth risk correlation information between a plurality of device health attributes of each completed historical minimum production unit as well as a combination of the plurality of device health attributes, and the quality and safety event(s) based on the historical construction data; and construct the safety risk database based on the completed historical minimum production units, the plurality of internal attributes, the plurality of external attributes, the plurality of device health attributes, the historical accident(s), the first risk correlation information, the second risk correlation information, and the fourth risk correlation information.

The device health attributes refer to data and information reflecting a service status of a device. For example, a device health attribute may include a dynamic parameter related to an operation status, a reliability and maintenance status of a mechanical device, a tool or a facility used in the engineering construction process, or the like. Exemplary device health attributes may include a load rate, a service time and a maintenance record of a tower crane, a rotation speed and a fault count of a concrete mixer, or the like.

The fourth risk correlation information refers to a correlation between the device health attributes and/or the combination of the device health attributes of a completed historical minimum production unit, and a risk of an accident occurrence. The fourth risk correlation information may indicate the risk of the accident occurrence by a probability, where a higher probability means a greater risk.

In some embodiments, a manner for the processor to determine the fourth risk correlation information is similar to the manner for determining the first risk correlation information, specific descriptions may be found in the related descriptions above (e.g., step 310). In some embodiments, the processor may add data related to the device health attributes, the combination of the device health attributes, and the fourth risk correlation information to the safety risk database.

It is understandable that device health attributes are usually real-time or near real-time dynamic parameters. By introducing the device health attributes and the fourth risk correlation information, an ability of the system to capture time-varying risks and warning sensitivity of the system during the construction process can be significantly enhanced, which is particularly applicable to risk scenarios caused by device performance attenuation or sudden faults.

In some embodiments, the processor may obtain a hazard degree of each of the one or more risk points and determine a risk level of the risk point based on the risk probability and the hazard degree of the risk point.

The risk level refers to an urgency of an accident, where a higher risk level means a more urgent accident.

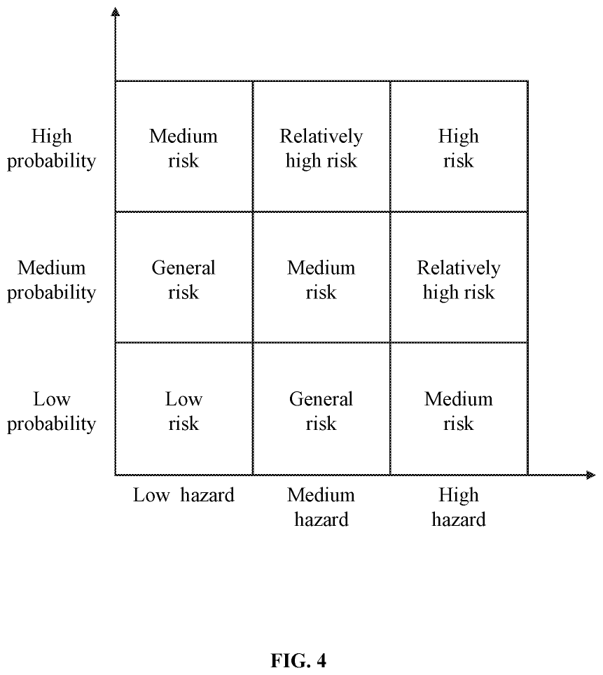

FIG. 4 is a schematic diagram illustrating exemplary risk levels according to some embodiments of the present disclosure. As illustrated in FIG. 4, the processor may determine a probability level of an accident based on a risk probability. For example, a risk probability less than 10% is a low probability, a risk probability of 10% to 50% is a medium probability, a risk probability greater than 50% is a high probability, etc. The processor may also determine a hazard level corresponding to an accident based on a preset rule. An exemplary hazard level may include a low hazard, a medium hazard, a high hazard, or the like. For example, abrasion corresponds to a low hazard, falling from height corresponds to a high hazard, and an event causing a certain economic loss (e.g., an economic loss of 100,000 CNY) corresponds to a medium hazard. An exemplary risk level may include a low risk, a general risk, a medium risk, a relatively high risk, a high risk, or the like. An exemplary risk level may also be represented by a number, such as 80%, 40%, etc., where a larger number indicates a higher risk level.

In some embodiments of the present disclosure, by determining the risk level of an accident based on the risk probability and the hazard degree, the risk level of the accident can be better evaluated, accidents with higher risk levels can be prioritized, and a better accident control effect can be achieved.

In some embodiments, the processor may provide a warning for an accident based on a preset warning rule. An exemplary warning rule may include one or more of the following: providing a warning for an accident with a risk level of general risk or above; providing a warning when the risk level of the accident increases (e.g., providing a warning when the risk level increases due to an irregular construction process); providing a warning if a duration of a risk level exceeds a threshold (e.g., 12 hours, 24 hours, etc.) without investigation and warning, etc.

In some embodiments of the present disclosure, a first risk warning can be provided in a timely manner through the warning rule, facilitating a timely investigation of the accident.

In some embodiments, the processor may provide suggestions for accident investigation and rectification. For example, if a current minimum production unit includes two attributes M and N (internal attributes and/or external attributes), and the corresponding risk level is the medium risk, the processor may query attribute combinations including the attributes M and N in the safety risk database and take attribute combinations with a risk level lower than medium risk as investigation suggestions. For example, if the safety risk database includes an attribute combination L, M, N with a low risk level, the attribute L may have reduced the risk level of attributes M and N, and the investigation suggestion may include adding the attribute L.

In some embodiments, to more conveniently and intuitively determine the occurrence location and the risk level of the accident, the processor may also display a visual risk display icon through a model.

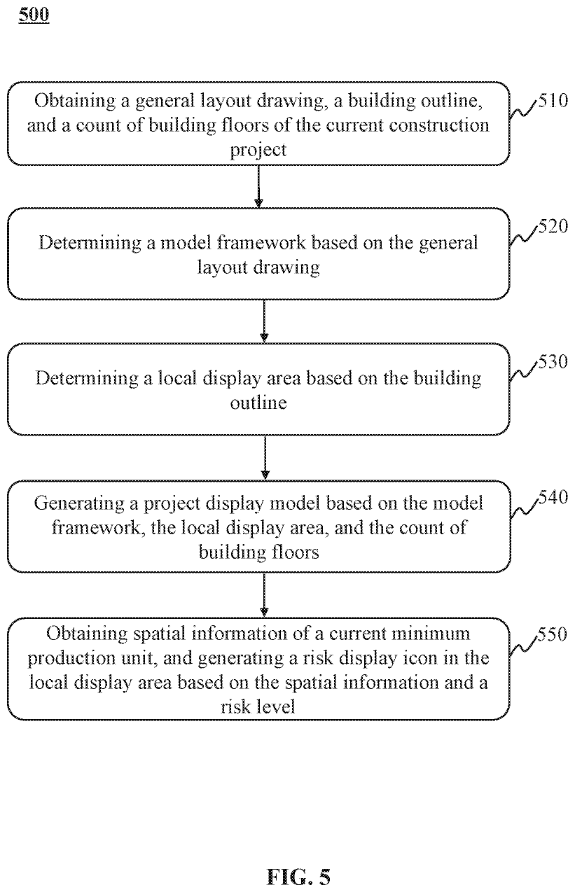

FIG. 5 is a flowchart illustrating an exemplary process for generating a risk display icon according to some embodiments of the present disclosure. As illustrated in FIG. 5, a process 500 may include the following steps. In some embodiments, the process 500 may be performed by the engineering safety risk management system (e.g., the server 120 of the engineering safety risk management system 100, modules of the engineering safety risk management system 1500).

Step 510, obtaining a general layout drawing, a building outline, and a count of building floors of the current construction project.

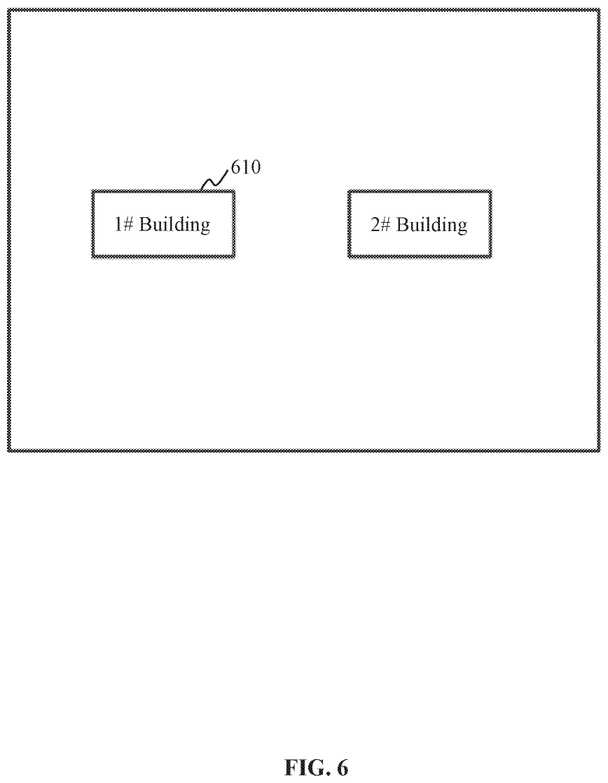

The general layout drawing refers to a detailed drawing showing a site layout of an entire construction project. The general layout drawing includes an overall planning of a terrain of a project location, an arrangement of buildings, roads, landscaping, equipment placement, and other infrastructure. FIG. 6 is a schematic diagram illustrating an exemplary general layout drawing according to some embodiments of the present disclosure. As illustrated in FIG. 6, the general layout drawing may include a building outline 610.

The building outline refers to an edge line of a building depicted in the general layout drawing. As illustrated in FIG. 6, the building outline 610 may show an external shape and a floor area of the building.

The count of building floors refers to a total count of floors of a building from the ground to the top, including above-ground and underground floors. The count of building floors shows a height and spatial arrangement of the building.

In some embodiments, the general layout drawing, the building outline, and the count of building floors of the current construction project may be obtained based on construction data (e.g., a construction drawing) of the current construction project.

Step 520, determining a model framework based on the general layout drawing.

The model framework refers to a framework of a project display model. A project display model refers to a physical model for displaying risk points and risk probabilities of the risk points. In some embodiments, the processor may convert the general layout drawing into an axonometric drawing and use the axonometric drawing as the framework of the project display model. The processor may convert the general layout drawing into the axonometric drawing in a manner of projection.

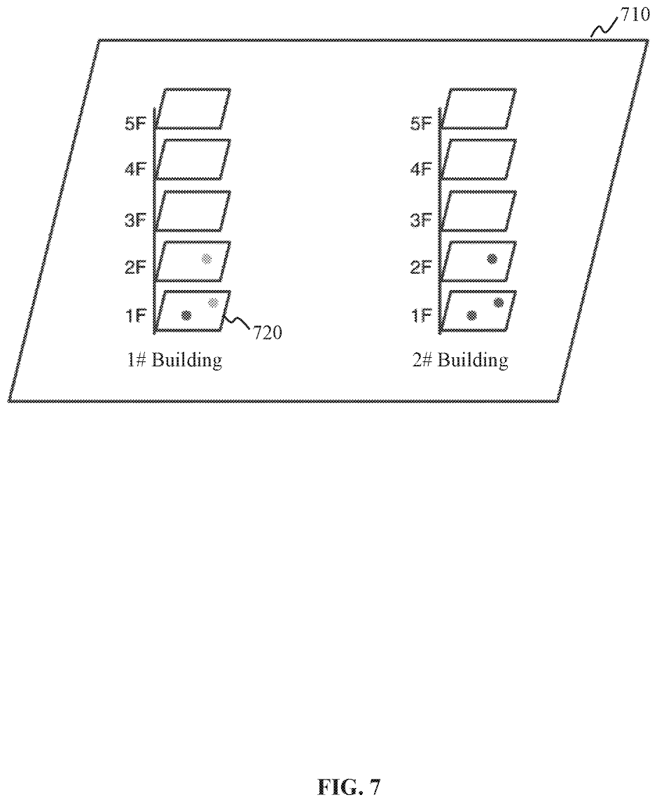

FIG. 7 is a schematic diagram illustrating an exemplary project display model according to some embodiments of the present disclosure. As illustrated in FIG. 7, a model framework 710 is obtained by converting the general layout drawing into an axonometric drawing through projection.

Step 530, determining a local display area based on the building outline.

The local display area refers to a partial area of the current construction project displayed in the project display model. In some embodiments, the processor may use a thumbnail of the building outline in the axonometric drawing as the local display area for displaying risk points and risk probabilities.

Step 540, generating a project display model based on the model framework, the local display area, and the count of building floors.

In some embodiments, as illustrated in FIG. 7, the processor may copy the thumbnail of the building outline within the model framework multiple times (a count of copies is equal to the count of building floors), then translate the copies such that each translated floor does not overlap and is evenly spaced, and use the copied results as a plurality of local display areas.

In some embodiments, the project display model is a 2.5D model.

In some embodiments of the present disclosure, the 2.5D project display model can at least achieve the following effects: technically simpler, without the need to spend more manpower and costs to produce complex physical models (e.g., Building Information Modeling (BIM)), and only simple operations such as projection of the general layout drawing are required; only key information (e.g., risk point location, risk level) is displayed with less interference, while other models (e.g., BIM models) have complex internal components and more interfering information, which may easily block key information; sufficiently concise to visually display all information, including floors, coordinates, risk levels, etc., avoiding information omission.

Step 550, obtaining spatial information of the current minimum production unit, and generating a risk display icon in the local display area based on the spatial information and the risk level.

The spatial information refers to spatial position information of the minimum production unit. For example, the spatial information may include a coordinate range of the minimum production unit on a drawing. As another example, the spatial information may include location information of the minimum production unit during the construction process, such as building and floor information, or the like. In some embodiments, the spatial information may be obtained by parsing the construction data (e.g., the construction drawing).

The risk display icon refers to an identifier for displaying the location and risk level of a risk point. As illustrated in FIG. 7, there are 2 risk display icons 720 on the 1st floor of Building 1, indicating that there are two risk points on the 1st floor of Building 1. In some embodiments, the risk display icon may also show the risk level through different colors. For example, green represents a low risk or no risk; yellow represents a medium risk; orange represents a relatively high risk; red represents a high risk, or the like.

In some embodiments, the processor may determine the position for generating the risk display icon in the local display area based on the spatial information, and determine the color of the risk display icon based on the risk level. For more descriptions of determining the risk level, reference may be found in the relevant parts above (e.g., FIG. 3, FIG. 4, etc.). For example, the processor may obtain the historical construction data based on step 210 of process 200; then determine the first risk correlation information between the plurality of internal attributes of the each of the plurality of completed historical minimum production unit as well as the combination of the plurality of internal attributes, and the quality and safety event(s) based on the historical construction data according to step 310 of process 300; determine the plurality of current minimum production units of the current construction project and the current internal attributes of the each of the plurality of current minimum production units; determine one or more risk points of the current minimum production unit and the risk probability corresponding to the each of the one or more risk points based on the current internal attributes and the first risk correlation information, and determine the risk level corresponding to the each risk point in combination with the schematic diagram shown in FIG. 4.

In some embodiments, the spatial information at least includes drawing information.

In some embodiments, in response to determining that a construction drawing is updated, the processor may determine change information of a component of the updated construction drawing; and adjust the risk display icon in the local display area based on the change information.

It is understandable that when the construction drawing is updated, only partial adjustments (i.e., adjustments to some components of the construction drawing) may be made instead of adjusting the entire drawing. For example, the construction drawing may be updated for a certain floor.

The change information includes spatial change information and attribute change information.

The spatial change information refers to a change in space of a construction area of a minimum production unit. For example, a change in an electrical laying line, or the like.

The attribute change information refers to a change in a current internal attribute and/or a current external attribute of a minimum production unit. For example, personnel allocation of the minimum production unit, construction period adjustment of the minimum production unit, weather change, or the like.

In some embodiments, the processor may determine the change information of the component of the updated construction drawing based on relative coordinates of a frame corner point of the construction drawing before the update and a corner point of an updated area, and coordinates of the corner point of the updated area on the updated construction drawing.

In some embodiments, the processor may adjust the position of the risk display icon in the local display area of the project display model based on the spatial change information; and adjust the risk level of the risk display icon based on the attribute change information (e.g., determine the risk level corresponding to the changed attributes through a method similar to those in FIG. 3 and FIG. 4 based on the changed attributes).

In some embodiments of the present disclosure, when the drawing changes, the position and risk level of the risk display icon are updated accordingly, which can more clearly and accurately determine an occurrence location and a probability of the quality and safety event(s), conduct targeted investigation, and achieve a better quality and safety event management effect.

In some embodiments, an accident also has a time attribute, that is, the occurrence location and probability of the accident change with time. The project display model may sort and connect all accidents at different time points in chronological order to form an animation of risk evolution, which facilitates accident control personnel to understand the change of the accident and better perform accident control.

In some embodiments, the local display area of the project display model may be related to a corresponding relevant drawing such as a floor plan, an elevation view, a sectional view, a detailed view, etc., and simultaneously related to all documents and data of the corresponding floor. That is, the project display model displays thumbnail information such as building outlines, risk display icons, etc., but when focusing on a specific local display area (e.g., a certain floor), detailed information such as correlated plan views, elevation views, sectional views, node detailed views, etc., may be displayed, and furthermore, correlated information such as risk points, task sheets, inspection sheets, acceptance sheets, etc., during actual construction may be displayed.

In some embodiments of the present disclosure, the relevant drawings of the local display area and the correlated information during actual construction can more intuitively display the personnel distribution at a certain historical moment, the current real-time personnel distribution, the cost and resource distribution, etc., which can better judge whether the personnel distribution meets the progress and construction requirements, whether the cost distribution meets expectations, and improve decision-making efficiency; in addition, if a quality and safety event occurs, it can also more conveniently and quickly investigate the cause of the accident and the relevant responsible persons.

FIG. 8A is a flowchart illustrating an exemplary process for engineering safety risk management according to some embodiments of the present disclosure. As illustrated in FIG. 8A, a process 800 may include the following steps. In some embodiments, the process 800 may be performed by the engineering safety risk management system (e.g., the server 120 of the engineering safety risk management system 100, modules of the engineering safety risk management system 1500).

Step 810, determining a target vector based on data collected from the current construction project.

In some embodiments, the data collected from the current construction project may include the on-site engineering collected data. The on-site engineering collected data refers to engineering-related data collected at an on-site engineering site. For example, the on-site engineering collected data may include on-site engineering characteristic data, on-site risk characteristic data, or the like. The on-site engineering characteristic data refers to engineering characteristic data collected at an engineering site. The engineering characteristic data refers to data and information related to the engineering project, such as an engineering type (e.g., a transportation engineering, a building construction engineering, a water conservancy engineering, etc.), an engineering scale (e.g., 0-100,000 cubic meters, 100,000-200,000 cubic meters, etc.), or the like. The on-site risk characteristic data refers to risk characteristic data collected at an engineering site. More descriptions of risk characteristic data may be found in the related descriptions below (e.g., step 831).

In some embodiments, the processor may obtain on-site engineering collected data in one or more manners. For example, the processor may determine the risk characteristic and its value-taking condition through a risk characteristic tree, then directly obtain real-time collected data related to the corresponding risk characteristic at the engineering site through a data collection device (e.g., the data collection device 110), automatically judge and assign a value to the risk characteristic based on the real-time collected data and the corresponding value-taking condition, determine a risk characteristic value, and thereby determine the on-site risk characteristic data. As another example, the processor may determine the on-site engineering characteristic data through engineering data recorded in a storage device internal or external to the engineering safety risk management system 1500. More descriptions of the risk characteristic data, the value-taking condition, and the risk characteristic value may be found in the related descriptions below.

The target vector refers to a characteristic vector formed by the on-site engineering collected data. In some embodiments, the target vector at least includes an on-site engineering characteristic element and an on-site risk characteristic element. The on-site engineering characteristic element refers to an element corresponding to the on-site engineering characteristic data. The on-site risk characteristic element refers to an element corresponding to the on-site risk characteristic data. For example, the target vector may be {[engineering type A, engineering scale B], [(risk characteristic 1: risk characteristic value 1), (risk characteristic 2: risk characteristic value 2), . . . , (risk characteristic n: risk characteristic value n)]}, or the like. More descriptions of the risk characteristic data and the risk characteristic values may be found in the related descriptions below.

In some embodiments, the processor may determine the target vector based on accident vectors in an accident vector library and the on-site engineering collected data. For example, the processor may determine a matched sub-vector library in the accident vector library based on the on-site engineering characteristic data in the on-site engineering collected data; obtain a standard format of the accident vector based on the accident vector in the sub-vector library; fill the on-site risk characteristic data in the on-site engineering collected data into a risk characteristic element part in the standard format of the accident vector, and determine the target vector. More descriptions of the accident vector library, the sub-vector library, and the accident vector may be found in the related descriptions below.

Step 820, determining the safety risk data of the current construction project based on the target vector and the safety risk model.

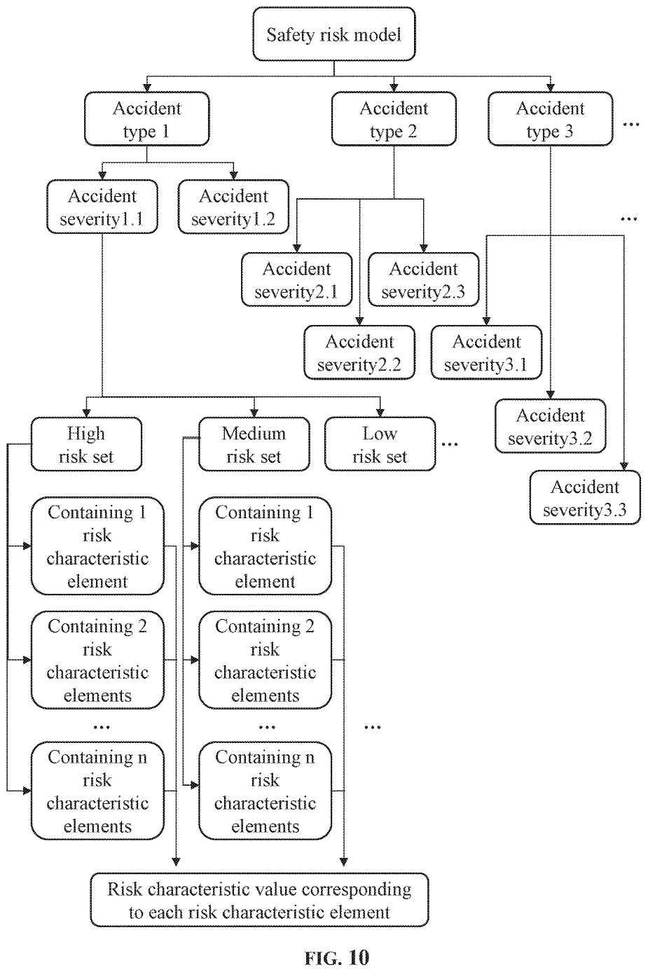

The safety risk model refers to a model for determining the engineering safety risk. In some embodiments, the safety risk model may include data related to the accident and the risk characteristic. FIG. 10 is a schematic diagram illustrating an exemplary safety risk model according to some embodiments of the present disclosure. As illustrated in FIG. 10, the safety risk model may include accident types (e.g., accident type 1-accident type 3, etc.), accident severity (i.e., accident characteristic elements and their corresponding accident characteristic values; it is understandable that accident severity corresponds to accident types, such as accident severity 1.1-accident severity 1.2 corresponding to accident type 1, accident severity 2.1 accident severity 2.3 corresponding to accident type 2, accident severity 3.1-accident severity 3.3 corresponding to accident type 3, etc.), risk levels, risk characteristic elements with different preset counts and their corresponding risk characteristic values, or the like. More descriptions of constructing the safety risk model may be found in FIG. 8B and the related descriptions thereof.

In some embodiments, the safety risk data may include warning information related to an engineering safety risk.

The warning information refers to warning information of the engineering safety risk. The warning information may be represented in different forms. For example, the warning information may be represented in a text form, a sound form, a light form, or the like. Exemplary warning information may be a short message such as “The foundation anchorage of the tower crane has a risk of failure and may overturn, please evacuate the site”, a siren indicating a fire, or the like.

In some embodiments, the processor may determine warning information related to an engineering safety risk through a third preset rule based on the target vector and the safety risk model and send the warning information to a user. The third preset rule may be preset based on experience or requirements. An exemplary third preset rule may be querying the safety risk model based on the target vector; if a risk level of an on-site risk characteristic element in the target vector and a certain accident characteristic element exceeds a risk level threshold, processing and generating warning information from relevant information and sending it to the user. The risk level threshold may be preset based on experience or requirements. A specific processing and generation manner may be implemented by a machine learning model, a preset algorithm, or the like. A specific sending manner may be sending to a user terminal through a network, or the like.

In some embodiments, the risk level threshold is related to a construction stage of the current construction project. The processor may determine a construction stage of the project based on data collected from the current construction project (e.g., a construction schedule, an actual completed engineering quantity, etc.) and adjust the risk level threshold for different risk characteristics.

In some embodiments, the processor may call a preset stage-risk mapping table to determine the risk level threshold. The mapping table defines calibrated risk level thresholds applicable to various risk characteristics (or their corresponding accident characteristics) at different construction stages.

For example, in a “foundation pit excavation stage”, the processor may lower risk level threshold corresponding to risk characteristics such as “geological stability” and “slope support”. As another example, in a “decoration stage”, the processor may lower risk level thresholds corresponding to risk characteristics such as “fire hazard” and “temporary electricity use”. By adjusting the risk level threshold based on the construction stage of the current construction project, adaptive adjustment of a focus of risk control can be achieved, so that limited monitoring resources can always focus on the most frequent risks in the current stage, thereby improving the refinement level of safety management and resource utilization efficiency as a whole.

In some embodiments, the processor may input known safety risk data into a time series algorithm (e.g., LSTM, or the like) to predict a risk development trend. For example, the known safety risk data may be input into the time series algorithm for training and analysis, thereby predicting that “a settlement rate of a certain slope will exceed a safety threshold in 3 days”. The function realizes a technical upgrade from “real-time warning” of existing risks to “advanced prediction” of potential risks, providing a decision-making basis for taking forward-looking intervention measures and preventing the deterioration of the situation.

In some embodiments, the processor may determine the safety risk model based on the on-site engineering characteristic element in the target vector. It is understandable that the processor may set different safety risk models corresponding to different sub-vector libraries, that is, set safety risk models corresponding to respective engineering types and engineering scales based on accident vectors of different engineering types and engineering scales. In this way, complex safety risk data can be classified based on engineering types and engineering scales, enhancing the pertinence during risk information query and effectively improving query efficiency. Exemplarily, the processor may determine the safety risk model corresponding to the respective engineering type and engineering scale based on the engineering type and engineering scale in the on-site engineering characteristic element in the target vector.

Subsequently, the processor may query the safety risk model based on the on-site risk characteristic element in the target vector to determine a target accident characteristic element whose correlation relationship with the on-site risk characteristic element meets a second preset condition and a risk level corresponding to the target accident characteristic element. The target accident characteristic element refers to an accident characteristic element with potential safety risks and requiring attention. The second preset condition refers to a condition for screening the target accident characteristic element based on the correlation relationship. The second preset condition may be set based on experience or requirements. Exemplarily, the second preset condition may be determining an accident characteristic element in the safety risk model whose accident characteristic value exceeds an accident characteristic value threshold and whose correlation relationship with the on-site risk characteristic element exceeds a correlation relationship threshold as the target accident characteristic element. The correlation relationship threshold may be set based on experience or requirements.

Finally, the processor may determine the safety risk data based on the target accident characteristic element, the risk level, and a warning rule. The warning rule refers to a specific rule for generating warning information. For example, the warning rule may be, when the risk level exceeds a risk level threshold (set based on experience or requirements), determining the safety risk data as the target accident characteristic element with warning information marked in red and sending it to the user. As another example, the warning rule may be, when the risk level exceeds a first risk level threshold (set based on experience or requirements) but does not exceed a second risk level threshold (set based on experience or requirements), determining the safety risk data as the target accident characteristic element with warning information marked in yellow and sending it to the user.

In the embodiments of the present disclosure, by querying the safety risk model based on the on-site risk characteristic element in the target vector to determine the target accident characteristic element whose correlation relationship with the on-site risk characteristic element meets the second preset condition and the risk level corresponding to the target accident characteristic element; and determining the safety risk data based on the target accident characteristic element, the risk level, and the warning rule, accident characteristics with potential engineering safety risks that require key attention in the implemented engineering data can be identified accurately and efficiently, and appropriate warning information can be generated and sent to the user, reducing potential safety hazards.

In some embodiments, the processor may determine the safety risk model based on the on-site engineering characteristic element in the target vector. More descriptions of determining the safety risk model may be found in the related descriptions above.

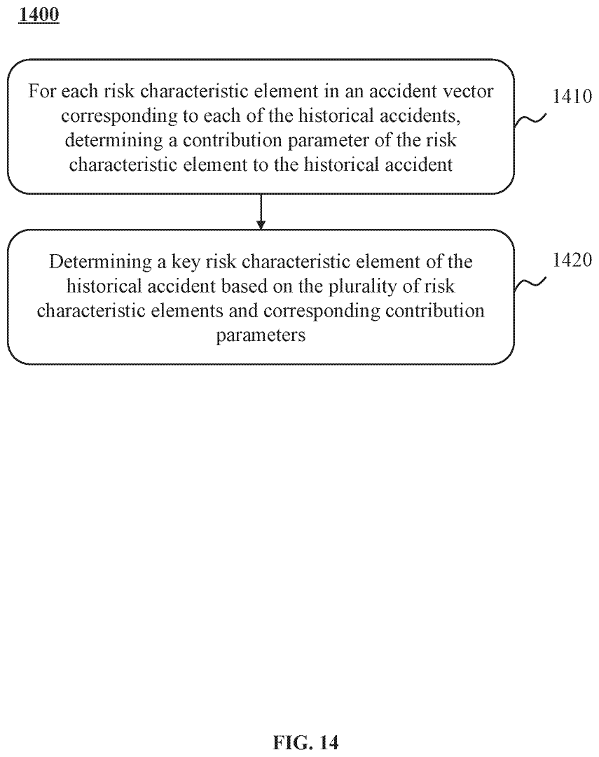

Subsequently, the processor may query the safety risk model based on the target vector to determine a key risk characteristic element of the historical accident. The key risk characteristic element refers to a risk characteristic element that has a critical impact on the accident. For example, a risk characteristic element with the strongest correlation relationship, or the like. In some embodiments, the processor may determine the key risk characteristic element of the accident based on a fourth preset rule. The fourth preset rule may be preset based on experience or requirements. An exemplary fourth preset rule may be querying the safety risk model and determining a risk characteristic element, among the on-site risk characteristic elements of the target vector, with the strongest correlation relationship with the accident characteristic element of the accident as the key risk characteristic element. More descriptions of the key risk characteristic element may be found in FIG. 14 and the related descriptions thereof.

Finally, the processor may determine the safety risk data of the current construction project based on the key risk characteristic element. For example, the processor may determine the warning information based on the key risk characteristic element and the warning rule and send it to the user. The warning rule may be processing and generating warning information from relevant information of the key risk characteristic element and sending it to the user. A specific processing and generation manner may be implemented by a machine learning model, a preset algorithm, or the like. More descriptions of the warning rule and the warning information may be found in the related descriptions above.

In the embodiments of the present disclosure, by determining the safety risk model based on the on-site engineering characteristic element in the target vector; querying the safety risk model based on the target vector to determine the key risk characteristic element of the accident; and determining the safety risk data of the current construction project based on the key risk characteristic element, the key risk characteristic that has the greatest impact on the accident are given priority for identification, facilitating the subsequent determination of appropriate warning information for timely and effective handling, and improving the overall capability of risk control.

In some embodiments, the processor may monitor the target vector and the safety risk model and their data changes in real time, and dynamically update the safety risk data of the current construction project (e.g., sending warning information related to an engineering safety risk to the user).

In the embodiments of the present disclosure, by determining the target vector based on on-site engineering collected data; and determining the safety risk data of the current construction project based on the target vector and the safety risk model, various risk characteristics can be identified efficiently, comprehensively, and accurately based on the actual situation of the construction site, risk level assessment can be performed, and while quickly identifying various on-site risks and their causes, comprehensive consideration of multiple influencing factors is taken into account, making the risk identification results more accurate and reliable.

FIG. 8B is a flowchart illustrating an exemplary process for constructing a safety risk model according to some embodiments of the present disclosure. As illustrated in FIG. 8B, a process 830 may include the following steps. In some embodiments, the process 830 may be performed by the engineering safety risk management system (e.g., the server 120 of the engineering safety risk management system 100, modules of the engineering safety risk management system 1500).

Step 831, determining risk characteristic data of functional domains under a plurality of safety risk control types based on a safety responsibility list.

The safety responsibility list refers to a responsibility list related to engineering safety for a plurality of positions (e.g., responsible personnel, supervisors, safety officers, construction personnel, designers, etc.) under a plurality of engineering entities (e.g., construction entities, supervision entities, construction units, design entities, survey entities, etc.). The safety responsibility list may include a content such as an industry specification, an enterprise system, a job responsibility, an output time limit, or the like.

A safety risk control type refers to a manner type for conducting safety risk control. For example, the safety risk control types may include a self-prevention type, an external control type, an adjustment type, a repair type, and an improvement type. In some embodiments, the processor may directly obtain the safety risk control types from the safety responsibility list.

The functional domains refer to specific task modules divided based on the safety risk control types. For example, when a safety risk control type is the self-prevention type, its subordinate functional domains may include an awareness element, a behavioral element, and an instruction element. As another example, when a safety risk control type is the improvement type, its subordinate functional domains may include a system optimization and a technological innovation.

The risk characteristic data refers to information related to risk characteristics (i.e., characteristics with potential safety risks), for example, upload information of a safety education material, wearing information of a safety protective device, regular device inspection information, or the like. In some embodiments, the risk characteristic data may correspond to a potential hazard. For example, the wearing information of safety protective device may correspond to a potential hazard such as an object strike, a cut, a scald, or the like (i.e., a potential hazard that may be caused by not wearing safety protective device).

In some embodiments, the user may mark the safety risk control types, the functional domains, and the corresponding risk characteristic data in the safety responsibility list based on requirements, experience, or the like, and the processor may directly obtain the safety risk control types, the functional domains, and the risk characteristic data based on the marked contents.

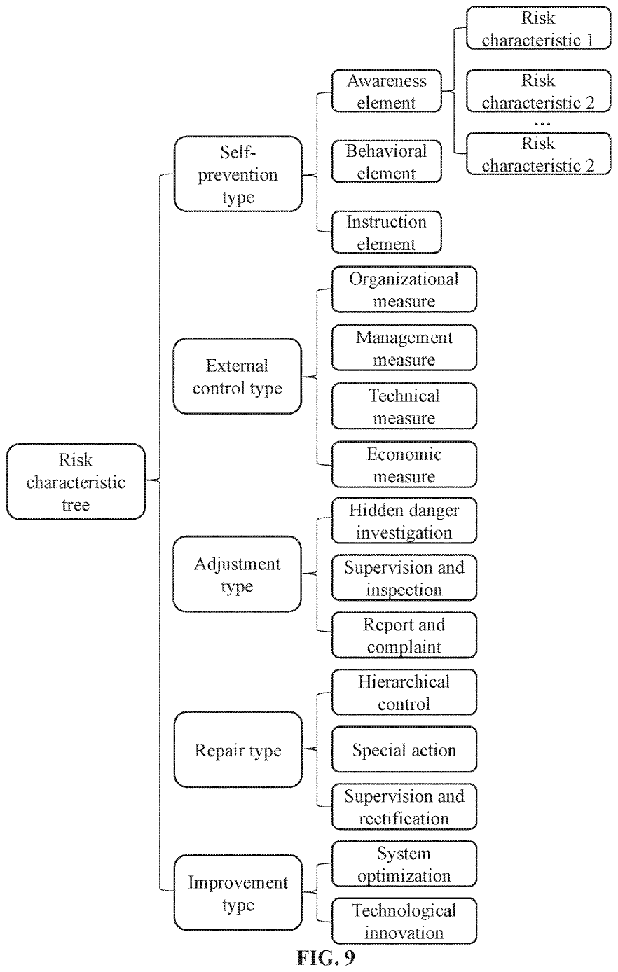

A risk characteristic tree refers to a tree-like hierarchical structure for analyzing risk characteristics. FIG. 9 is a schematic diagram illustrating an exemplary risk characteristic tree according to some embodiments of the present disclosure. As illustrated in FIG. 9, the risk characteristic tree may include at least three layers, wherein a first layer includes the plurality of safety risk control types (e.g., the self-prevention type, the external control type, the adjustment type, the repair type, the improvement type, etc.), a second layer includes functional domains (e.g., the awareness elements, the behavioral element, the instruction element, an organizational measure, a management measure, a technical measure, an economic measure, a hidden danger investigation, a supervision and inspection, a report and complaint, a hierarchical control, a special action, a supervision and a rectification, the system optimization, the technological innovation, etc.) included in each of the plurality of safety risk control types, and a third layer includes the risk characteristic data (e.g., risk characteristic 1-risk characteristic n, etc.) corresponding to each of the functional domains.

In some embodiments, the risk characteristic data at least includes a risk characteristic value and a value-taking condition corresponding to the risk characteristic value. The risk characteristic value refers to a quantified value of a risk characteristic. For example, when the risk characteristic is the safety education material, the risk characteristic value may be 0, 0.5, or 1. As another example, when the risk characteristic is the regular device inspection, the risk characteristic value may be 0 or 1. The value-taking condition refers to an assignment rule for the risk characteristic value. For example, when the risk characteristic is the safety education material, the value-taking condition may be that if the construction personnel do not upload the safety education material before an engineering construction, the risk characteristic value is 0; if the construction personnel upload the safety education material during the engineering construction, the risk characteristic value is 0.5; if the construction personnel have uploaded the safety education material before the engineering construction, the risk characteristic value is 1. As another example, when the risk characteristic is the regular equipment inspection, the value-taking condition may be that if the safety officers conduct the regular device inspection, the risk characteristic value is 1; if the safety officers do not conduct regular device inspection, the risk characteristic value is 0. In some embodiments, the value-taking condition may be preset based on experience or requirements, and the processor may automatically collect relevant data of the risk characteristic, judge and assign a value to the risk characteristic based on the value-taking condition, and determine the risk characteristic value corresponding to the risk characteristic.

In some embodiments, the processor may determine the risk characteristic tree based on the safety responsibility list. For example, the user may mark the safety risk control types, the functional domains, and corresponding risk characteristic data in the safety responsibility list based on requirements, experience, or the like, and the processor may determine the risk characteristic tree based on the marked contents.

In the embodiments of the present disclosure, by determining a risk characteristic tree with a three-layer structure based on the safety responsibility list, comprehensive safety risk control types, functional domains, and risk characteristic data can be summarized based on the safety performance obligations of various entities and positions and intuitively displayed in a tree structure, which facilitates subsequent accident attribution based on the risk characteristic data and determination of accurate risk factors.

Step 832, determining a plurality of accident vectors corresponding to historical accidents based on data related to the historical accidents and the risk characteristic data. More descriptions of the data related to the historical accidents may be found in FIG. 2 and the related descriptions thereof.

An accident vector refers to a characteristic vector related to a historical accident. In some embodiments, the accident vector at least includes an engineering characteristic element, a risk characteristic element, and an accident characteristic element. The engineering characteristic element refers to an element corresponding to engineering characteristic data. The risk characteristic element refers to an element corresponding to risk characteristic data. More descriptions of the engineering characteristic data and the risk characteristic data may be found in the related descriptions above. The accident characteristic element refers to an element corresponding to accident characteristic data, and the accident characteristic data refers to data and information related to the historical accident, such as an accident type (e.g., a collapse type, an explosion type, an object strike type, an electric shock type, etc.), an accident severity (which may be expressed according to a national legal level and corresponding a value, e.g., a general accident, a major accident, a serious accident, a particularly serious accident, etc.). In some embodiments, the accident characteristic data at least includes an accident characteristic value and a value-taking condition corresponding to the accident characteristic value. The accident characteristic value refers to a quantified value of an accident. For example, when the accident is a foundation pit collapse, the accident characteristic value may be 0 or 1. As another example, when the accident is an explosion, the accident characteristic value may be 1, 2, 3, or 4. The value-taking condition refers to an assignment rule for the accident characteristic value. For example, when the accident is the foundation pit collapse, the value-taking condition may be that if no foundation pit collapse accident occurs, the accident characteristic value is 0; if the foundation pit collapse accident occurs, the accident characteristic value is 1. As another example, when the accident is the explosion, the value-taking condition may be that if the explosion accident is a general accident, the accident characteristic value is 1; if the explosion accident is a major accident, the accident characteristic value is 2; if the explosion accident is a serious accident, the accident characteristic value is 3; if the explosion accident is a particularly serious accident, the accident characteristic value is 4. In some embodiments, the value-taking condition may be preset based on experience or requirements, and the processor may automatically collect relevant data of the accident, judge and assign a value to the accident characteristic based on the value-taking condition, and determine the accident characteristic value corresponding to the accident. An exemplary accident vector may be {[engineering type C, engineering scale D], [(risk characteristic 1: risk characteristic value 1), (risk characteristic 2: risk characteristic value 2), . . . , (risk characteristic n: risk characteristic value n)], [(accident 1: accident characteristic value 1), (accident 2: accident characteristic value 2), . . . , (accident m: accident characteristic value m)]}, or the like.

In some embodiments, the processor may further determine engineering characteristic elements, risk characteristic elements, and accident characteristic elements related to the historical accidents based on the obtained historical accident data and risk characteristic data, and construct and determine a plurality of accident vectors corresponding to the historical accidents.

In some embodiments, the processor may unify a count of elements in the accident vectors to ensure that all accident vectors have a unified standard format. For example, the processor may take a union of the risk characteristic elements and accident characteristic elements in all accident vectors as the risk characteristic elements and accident characteristic elements in a standard format of the accident vectors, and fill missing parts with preset characters. For example, when the missing parts are filled with 0, if accident vector 1 is {[engineering type, engineering scale], [(risk characteristic 1: risk characteristic value 1), (risk characteristic 2: risk characteristic value 2)], [(accident 1: accident characteristic value 1)]}, and accident vector 2 is {[engineering type, engineering scale], [(risk characteristic 4: risk characteristic value 4), (risk characteristic 8: risk characteristic value 8)], [(accident 2: accident characteristic value 2), (accident m: accident characteristic value m)]}, the processor may determine a standard format of the accident vectors as {[engineering type, engineering scale], [(risk characteristic 1: risk characteristic value 1), (risk characteristic 2: risk characteristic value 2), (risk characteristic 4: risk characteristic value 4), (risk characteristic 8: risk characteristic value 8)], [(accident 1: accident characteristic value 1), (accident 2: accident characteristic value 2), (accident m: accident characteristic value m)]}; at this time, accident vector 1 converted to the standard format is {[engineering type, engineering scale], [(risk characteristic 1: risk characteristic value 1), (risk characteristic 2: risk characteristic value 2), (risk characteristic 4: 0), (risk characteristic 8: 0)], [(accident 1: accident characteristic value 1), (accident 2: 0), (accident m: 0)]}, and accident vector 2 converted to the standard format is {[engineering type, engineering scale], [(risk characteristic 1: 0), (risk characteristic 2: 0), (risk characteristic 4: risk characteristic value 4), (risk characteristic 8: risk characteristic value 8)], [(accident 1: 0), (accident 2: accident characteristic value 2), (accident m: accident characteristic value m)]}.

Step 833, constructing an accident vector library based on the plurality of accident vectors.

The accident vector library refers to a data set composed of the plurality of accident vectors. In some embodiments, the processor may integrate the plurality of accident vectors to construct the accident vector library.

Step 834, dividing the accident vector library into a plurality of sub-vector libraries based on the engineering characteristic element.

A sub-vector library refers to a further subdivided data set of the accident vector library. In some embodiments, the processor may divide the accident vector library into the plurality of sub-vector libraries based on the engineering characteristic element. For example, the processor may divide accident vectors with the same engineering type in the accident vector library into one sub-vector library. As another example, the processor may divide accident vectors with the same engineering scale in the accident vector library into one sub-vector library.

In some embodiments, for each of the plurality of sub-vector libraries, the processor may perform the steps 8351-8353 to construct a safety risk model.

Step 8351, determining correlation relationships between a plurality of risk characteristic elements and a plurality of accident characteristic elements in the sub-vector library.

The correlation relationship refers to a specific relationship indicating a correlation degree between things, for example, a strong correlation, a weak correlation, a no correlation, or the like. The correlation relationship may be represented by numbers, such as 100%, 60%, etc., where a larger number indicates a stronger correlation degree.

In some embodiments, the processor may determine the correlation relationships between the plurality of risk characteristic elements and the plurality of accident characteristic elements in the sub-vector library based on a first preset rule. The first preset rule may be preset based on experience or requirements. An exemplary first preset rule may be determining that there is a strong correlation relationship between an accident characteristic element with a non-zero accident characteristic value and a risk characteristic element with a non-zero risk characteristic value in each accident vector in the sub-vector library.

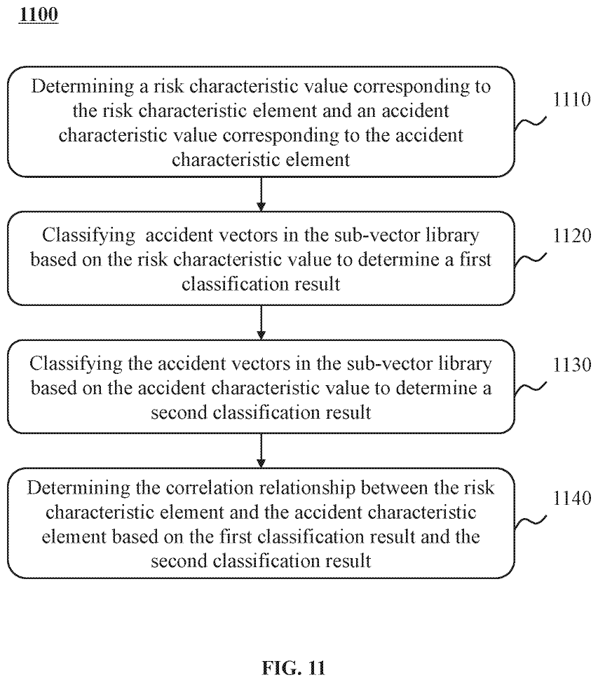

In some embodiments, for each of the plurality of risk characteristic elements and each of the plurality of accident characteristic elements in the sub-vector library, the processor may determine a risk characteristic value and an accident characteristic value, thereby determining a first classification result and a second classification result; and determine a correlation relationship between the risk characteristic element and the accident characteristic element based on the first classification result and the second classification result. More descriptions may be found in FIG. 11 and the related descriptions thereof.

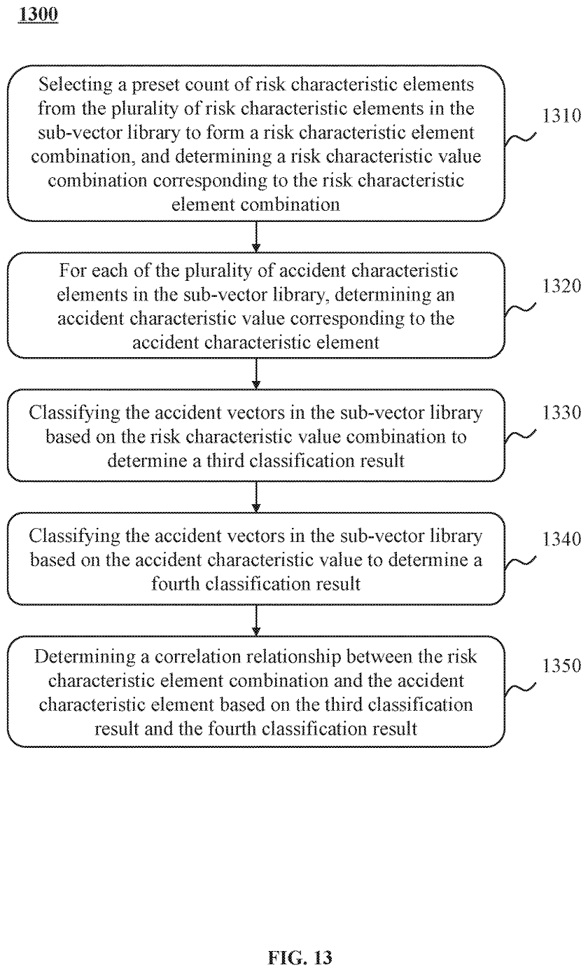

In some embodiments, the processor may select a preset count of risk characteristic elements from the plurality of risk characteristic elements in the sub-vector library to form a risk characteristic element combination, determine a risk characteristic value combination corresponding to the risk characteristic element combination and an accident characteristic value corresponding to each accident characteristic element; thereby determining a third classification result and a fourth classification result; and determine a correlation relationship between the risk characteristic element combination and the accident characteristic element based on the third classification result and the fourth classification result. More descriptions may be found in FIG. 13 and the related descriptions thereof.

Step 8352, determining risk levels corresponding to the plurality of risk characteristic elements and the plurality of accident characteristic elements in the sub-vector library based on the correlation relationship.

In some embodiments, the processor may determine the risk levels corresponding to the plurality of risk characteristic elements and the plurality of accident characteristic elements in the sub-vector library based on a second preset rule. The second preset rule may be preset based on experience or requirements. An exemplary second preset rule may be that determining a hazard level of the accident based on an accident characteristic value corresponding to an accident characteristic element; and determining a risk level corresponding to a risk characteristic element and the accident characteristic element based on the hazard level and the correlation relationship between the risk characteristic element and the accident characteristic element. A specific grading rule of the hazard level of the accident may be preset based on experience or requirements. For example, the processor may determine an accident with an accident characteristic value of 0 as no hazard, an accident with an accident characteristic value of 1 as low hazard, an accident with an accident characteristic value of 2 as medium hazard, and an accident with an accident characteristic value of 3 or 4 as high hazard; determine the risk level corresponding to the risk characteristic element and the accident characteristic element with a high hazard level and a strong correlation relationship as high risk, determine the risk level corresponding to the risk characteristic element and the accident characteristic element with a medium hazard level and a strong correlation relationship as medium risk, and determine the risk level corresponding to the risk characteristic element and the accident characteristic element with other hazard levels and other correlation relationships as low risk, or the like. The hazard level may be represented by numbers, such as 100%, 60%, etc., where a larger number indicates a higher hazard degree. When the hazard level and the correlation relationship are represented by numbers, the risk level may be determined based on a geometric calculation result between the aforementioned numbers. For example, the risk level may be set to be equal to a*hazard level+b*correlation relationship, where a and b are constants, or the like.

Step 8353, constructing a safety risk model based on the plurality of risk characteristic elements, the plurality of accident characteristic elements in the sub-vector library, the correlation relationships, and the risk levels.

In some embodiments, the processor may obtain each risk characteristic element, each accident characteristic element, and their corresponding correlation relationship and risk level respectively based on the aforementioned method, integrate them to construct the safety risk model.

By determining risk characteristic data of functional domains under a plurality of safety risk control types based on the safety responsibility list, where the risk characteristic data corresponds to a potential hazard; obtaining historical accident data of historical accidents; determining a plurality of accident vectors corresponding to the historical accidents based on the historical accident data (i.e., data related to the historical accidents) and the risk characteristic data, where the accident vectors at least includes an engineering characteristic element, a risk characteristic element, and an accident characteristic element; constructing an accident vector library based on the plurality of accident vectors; dividing the accident vector library into a plurality of sub-vector libraries based on the engineering characteristic element; for each sub-vector library: determining correlation relationships between a plurality of risk characteristic elements and a plurality of accident characteristic elements in the sub-vector library; determining risk level a corresponding to the plurality of risk characteristic elements and the plurality of accident characteristic elements in the sub-vector library based on the correlation relationships; and constructing a safety risk model based on the plurality of risk characteristic elements and the plurality of accident characteristic elements in the sub-vector library, the correlation relationships, and the risk level, various causal relationships between risk factors and accidents can be fully considered, and a safety risk model with the highest possible accuracy can be determined, thereby making the generation process of risk warning results faster and more accurate, facilitating relevant personnel to effectively handle risk factors subsequently, reducing the probability of safety accidents, realizing automated comprehensive analysis of risk factors, and reducing subjective errors caused by manual determination.

Step 8354, constructing the safety risk database based on the safety risk model.

In some embodiments, the processor may take the safety risk model as at least a part of the safety risk database.

In some embodiments, the processor may automatically convert newly added on-site accident/hazard disposal record into new accident vectors and add them to the accident vector library, and recalculate correlation relationships between risk characteristic elements and accidents, contribution parameters, etc., to avoid the model becoming outdated and ineffective.

FIG. 11 is a flowchart illustrating an exemplary process for determining a correlation relationship according to some embodiments of the present disclosure. As illustrated in FIG. 11, a process 1100 may include the following steps. In some embodiments, for each of the plurality of risk characteristic elements and each of the plurality of accident characteristic elements in the sub-vector library, the processor may perform the process 1100.

Step 1110, determining a risk characteristic value corresponding to a risk characteristic element and an accident characteristic value corresponding to an accident characteristic element.

In some embodiments, the processor may determine a value-taking condition corresponding to the risk characteristic element based on the risk characteristic tree; and determine the risk characteristic value corresponding to the risk characteristic element in the sub-vector library based on the historical accident data and the value-taking condition. For example, the processor may determine, based on the risk characteristic tree, that the value-taking condition corresponding to the risk characteristic element “special plan” in the sub-vector library with an engineering type of “foundation pit excavation” is: if a special plan is available before construction, the risk characteristic value is 1; if the special plan is available during construction, the risk characteristic value is 0.5; if no special plan is available after construction, the risk characteristic value is 0; and determine that the risk characteristic value corresponding to the risk characteristic element is 0 based on the historical accident data of foundation pit collapse without the special plan.

In some embodiments, the processor may determine the value-taking condition corresponding to the accident characteristic element based on a user input, etc.; and determine the accident characteristic value corresponding to the accident characteristic element in the sub-vector library based on the historical accident data and the value-taking condition. For example, the processor may determine that the value-taking condition corresponding to the accident characteristic element is assigning 1 to a general accident (classified according to national standards, e.g., an accident causing less than 3 deaths, or less than 10 serious injuries, or direct economic losses of less than CNY 10 million is a general accident) based on the user input; and determine that the accident characteristic value corresponding to the accident characteristic element is 1 based on the historical accident data of foundation pit collapse causing 1 death as a general accident.

More descriptions of the risk characteristic element, the risk characteristic value, the accident characteristic element, the accident characteristic value, the risk characteristic tree, the value-taking condition, the historical accident data, etc., may be found in FIGS. 8A-8B and the related descriptions thereof.

Step 1120, determining a first classification result by classifying the accident vectors in the sub-vector library based on the risk characteristic value.

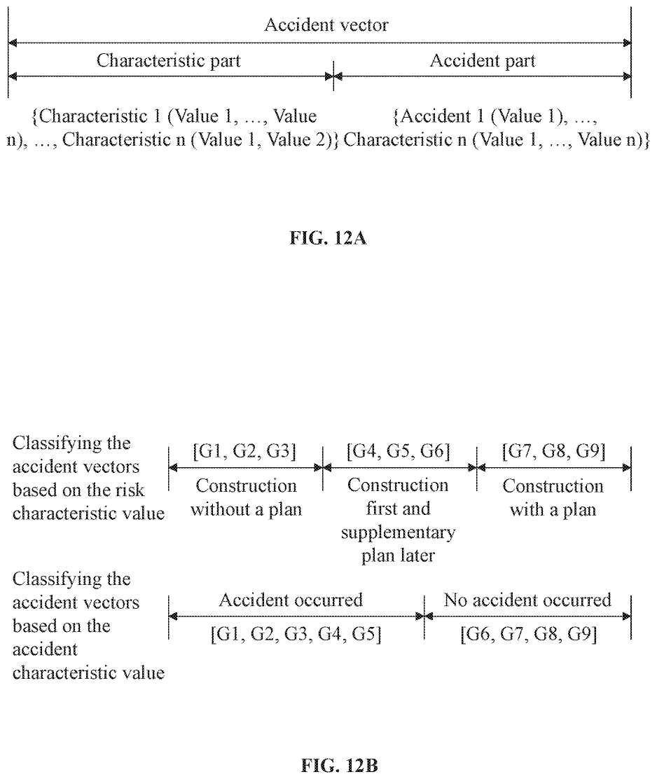

The first classification result refers to a classification result of accident vectors determined based on one risk characteristic element. FIG. 12A is a schematic diagram illustrating an exemplary accident vector according to some embodiments of the present disclosure. As illustrated in FIG. 12A, the accident vector may be divided into an engineering part (i.e., an engineering characteristic element part, not illustrated in FIG. 12A), a characteristic part (i.e., a risk characteristic element part), and an accident part (i.e., an accident characteristic element part). More descriptions of the accident vector may be found in FIGS. 8A-8B and the related descriptions thereof. In some embodiments, the processor may classify all accident vectors based on a count of types of risk characteristic values of a certain risk characteristic element to determine the first classification result. For example, the processor may classify all accident vectors into 3 classes based on 3 types of risk characteristic values (e.g., 0, 0.5, 1) of risk characteristic element 1, and determine first classification result 1 corresponding to risk characteristic element 1, i.e., accident vectors with a risk characteristic value of 0 of risk characteristic element 1 are Class 1, accident vectors with a risk characteristic value of 0.5 of risk characteristic element 1 are Class 2, and accident vectors with a risk characteristic value of 1 of risk characteristic element 1 are Class 3. FIG. 12B is a schematic diagram illustrating classifying accident vectors according to some embodiments of the present disclosure. As illustrated in FIG. 12B, if there are 9 accident vectors G1-G9 in the sub-vector library, for the risk characteristic element “special plan”, all accident vectors may be classified into 3 classes: Class 1 is [G1, G2, G3] of “construction without a plan” (i.e., the risk characteristic value is 0), Class 2 is [G4, G5, G6] of “construction first and supplementary plan later” (i.e., the risk characteristic value is 0.5), and Class 3 is [G7, G8, G9] of “construction with a plan” (i.e., the risk characteristic value is 1).

Step 1130, determining a second classification result by classifying the accident vectors in the sub-vector library based on the accident characteristic value.

The second classification result refers to a classification result of accident vectors determined based on one accident characteristic element. In some embodiments, the processor may classify all accident vectors based on a count of types of accident characteristic values of a certain accident characteristic element to determine the second classification result. For example, the processor may classify all accident vectors into 2 classes based on 2 types of accident characteristic values (e.g., 0, 1) of accident characteristic element 1, and determine second classification result 1 corresponding to accident characteristic element 1, i.e., accident vectors with an accident characteristic value of 0 of accident characteristic element 1 are Class 1, and accident vectors with a accident characteristic value of 1 of accident characteristic element 1 are Class 2. As illustrated in FIG. 12B, if there are 9 accident vectors G1-G9 in the sub-vector library, all accident vectors may be classified into 2 classes based on the accident characteristic value: Class 1 is [G1, G2, G3, G4, G5] of “accident occurred” (i.e., the accident characteristic value is 1), and Class 2 is [G6, G7, G8, G9] of “no accident occurred” (i.e., the accident characteristic value is 0).

Step 1140, determining a correlation relationship between the risk characteristic element and the accident characteristic element based on the first classification result and the second classification result.

In some embodiments, the processor may compare the first classification result and the second classification result. If a certain class in the first classification result is fully included in a certain class in the second classification result, it indicates that the risk characteristic element corresponding to the risk characteristic value of this class has a strong correlation relationship with the accident characteristic element corresponding to the accident characteristic value of this class; if a certain class in the first classification result is not fully included in a certain class in the second classification result, it indicates that the risk characteristic element corresponding to the risk characteristic value of this class has a weak correlation relationship with the accident characteristic element corresponding to the accident characteristic value of this class. As illustrated in FIG. 12B, [G1, G2, G3] of “construction without a plan” are all included in [G1, G2, G3, G4, G5] of “accident occurred”, so it may be determined that the risk characteristic element “construction without a plan” has a strong correlation with the accident characteristic element “accident occurred”; [G7, G8, G9] of “construction with a plan” are all included in [G6, G7, G8, G9] of “no accident occurred”, so it may be determined that the risk characteristic element “construction with a plan” has a strong correlation with the accident characteristic element “no accident occurred”; [G4, G5, G6] of “construction first and supplementary plan later” are partially included in [G1, G2, G3, G4, G5] of “accident occurred” and partially included in [G6, G7, G8, G9] of “no accident occurred”, so the risk characteristic element “construction first and supplementary plan later” has a weak correlation with both the accident characteristic element “accident occurred” and the accident characteristic element “no accident occurred”.

In some embodiments, when the correlation relationship is represented by a number, the processor may determine a ratio of a count of a certain class in the first classification result included in a certain class in the second classification result to a total count as the correlation relationship between the risk characteristic element corresponding to the risk characteristic value of this class and the accident characteristic element corresponding to the accident characteristic value of this class. For example, [G1, G2, G3] of “construction without a plan” are all included in [G1, G2, G3, G4, G5] of “accident occurred”, so it may be determined that the correlation relationship between the risk characteristic element “construction without a plan” and the accident characteristic element “accident occurred” is 100%; only 2 vectors of [G4, G5, G6] of “construction first and supplementary plan later” are included in [G1, G2, G3, G4, G5] of “accident occurred”, so it may be determined that the correlation relationship between the risk characteristic element “construction first and supplementary plan later” and the accident characteristic element “accident occurred” is 66.67%.

In some embodiments, all risk characteristic elements and all accident characteristic elements in the sub-vector library are traversed according to the aforementioned method to obtain the correlation relationships between all risk characteristic elements and all accident characteristic elements.

In the embodiments of the present disclosure, for each risk characteristic element and each accident characteristic element in the sub-vector library, by determining the risk characteristic value corresponding to the risk characteristic element and the accident characteristic value corresponding to the accident characteristic element; classifying the accident vectors in the sub-vector library based on the risk characteristic value to determine the first classification result; classifying the accident vectors in the sub-vector library based on the accident characteristic value to determine the second classification result; and determining the correlation relationship between the risk characteristic element and the accident characteristic element based on the first classification result and the second classification result, the correlation relationships between different risk characteristic elements and different accident characteristic elements can be clearly and intuitively obtained, and strongly correlated factors can be conveniently and quickly found for risk accidents, facilitating the handling of corresponding strongly correlated factors.

FIG. 13 is a flowchart illustrating an exemplary process for determining a correlation relationship according to some embodiments of the present disclosure. As illustrated in FIG. 13, a process 1300 may include the following steps. In some embodiments, the process 1300 may be performed by the processor.

Step 1310, forming a risk characteristic element combination by selecting a preset count of risk characteristic elements from the plurality of risk characteristic elements in the sub-vector library, and determining a risk characteristic value combination corresponding to the risk characteristic element combination.

In some embodiments, the processor may select a preset count (which may be set based on experience or requirements) of risk characteristic elements from the plurality of risk characteristic elements in the sub-vector library, combine these risk characteristic elements to determine as the risk characteristic element combination, then determine the risk characteristic values corresponding to these risk characteristic elements respectively, and combine these risk characteristic values to determine as the risk characteristic value combination corresponding to the aforementioned risk characteristic element combination. A specific method of determining the risk characteristic value corresponding to the risk characteristic element, reference may be made to FIGS. 8A-8B, FIG. 11, and the descriptions thereof.

Step 1320, for each of the plurality of accident characteristic elements in the sub-vector library, determining an accident characteristic value corresponding to the accident characteristic element. A specific method of determining the accident characteristic value corresponding to the accident characteristic element, reference may be made to FIGS. 8A-8B, FIG. 11, and the descriptions thereof.

Step 1330, determining a third classification result by classifying the accident vectors in the sub-vector library based on the risk characteristic value combination.

The third classification result refers to a classification result of accident vectors determined based on the risk characteristic value combination. In some embodiments, the processor may classify all accident vectors based on a count of types of risk characteristic value combinations to determine the third classification result. For example, when the preset count is 2, based on 2 types of risk characteristic values (e.g., 0, 1) of risk characteristic element 2 and 3 types of risk characteristic values (e.g., 0, 0.5, 1) of risk characteristic element 3, the processor may determine that the count of types of risk characteristic value combinations corresponding to the risk characteristic element combination composed of risk characteristic element 2 and risk characteristic element 3 is 6 (i.e., (0,0), (0,0.5), (0,1), (1,0), (1,0.5), (1,1)); and classify all accident vectors into 6 classes based on these 6 risk characteristic value combinations to determine the third classification result corresponding to the risk characteristic element combination.

Step 1340, determining a fourth classification result by classifying the accident vectors in the sub-vector library based on the accident characteristic value.

The fourth classification result refers to a classification result of accident vectors determined based on one accident characteristic element. A specific method of determining the fourth classification result, reference may be made to the aforementioned method of determining the second classification result.

Step 1350, determining a correlation relationship between the risk characteristic element combination and the accident characteristic element based on the third classification result and the fourth classification result.

In some embodiments, the processor may compare the third classification result and the fourth classification result; if a certain class in the third classification result is fully included in a certain class in the fourth classification result, it indicates that the risk characteristic element combination corresponding to the risk characteristic value combination of this class has a strong correlation relationship with the accident characteristic element corresponding to the accident characteristic value of this class; if a certain class in the third classification result is not fully included in a certain class in the fourth classification result, it indicates that the risk characteristic element combination corresponding to the risk characteristic value combination of this class has a weak correlation relationship with the accident characteristic element corresponding to the accident characteristic value of this class.

In some embodiments, when the correlation relationship is represented by a number, the processor may determine a ratio of a count of a certain class in the third classification result included in a certain class in the third classification result to a total count as the correlation relationship between the risk characteristic element combination corresponding to the risk characteristic value combination of this class and the accident characteristic element corresponding to the accident characteristic value of this class.

In some embodiments, all risk characteristic element combinations composed of risk characteristic elements with all preset counts, and all accident characteristic elements in the sub-vector library are traversed according to the aforementioned method to obtain the correlation relationships between all risk characteristic elements and all accident characteristic elements.

In the embodiments of the present disclosure, by selecting a preset count of risk characteristic elements from the plurality of risk characteristic elements in the sub-vector library to form a risk characteristic element combination and determining a risk characteristic value combination corresponding to the risk characteristic element combination; for each accident characteristic element in the sub-vector library, determining an accident characteristic value corresponding to the accident characteristic element; classifying the accident vectors in the sub-vector library based on the risk characteristic value combination to determine a third classification result; classifying the accident vectors in the sub-vector library based on the accident characteristic value to determine a fourth classification result; and determining the correlation relationship between the risk characteristic element combination and the accident characteristic element based on the third classification result and the fourth classification result, on the basis of determining the correlation relationship between a single risk characteristic element and an accident characteristic element, the correlation relationship between a combination composed of a plurality of risk characteristic elements and the accident characteristic element can be further determined. It is understandable that the occurrence of an accident is often not affected by a single factor; only by comprehensively considering multiple factors and their joint impacts can the determination result of important correlated elements corresponding to the accident be more accurate and in line with actual conditions.

FIG. 14 is a flowchart illustrating an exemplary process for determining a key risk characteristic element according to some embodiments of the present disclosure. As illustrated in FIG. 14, a process 1400 may include the following steps. In some embodiments, the process 1400 may be performed by the processor.

Step 1410, for each risk characteristic element in an accident vector corresponding to each of the historical accidents, determining a contribution parameter of the risk characteristic elements to the historical accident.

The contribution parameter refers to a parameter indicating a degree of impact of a risk characteristic element on an accident. A larger contribution parameter indicates a greater degree of impact of the risk characteristic element on the accident.

In some embodiments, the processor may determine the contribution parameter of the risk characteristic element to the historical accident based on a fifth preset rule. The fifth preset rule may be preset based on experience or requirements. An exemplary fifth preset rule may be directly determining the correlation relationship between the risk characteristic element and the corresponding accident characteristic element as the contribution parameter of the risk characteristic element to the historical accident.

In some embodiments, for each risk characteristic element, the processor may determine a first correlation parameter between each risk characteristic element and the accident.

The first correlation parameter is a parameter representing a correlation relationship between the risk characteristic element and a corresponding accident characteristic element of the accident vector corresponding to the historical accident. In some embodiments, the processor may determine the first correlation parameter according to the method of determining the correlation relationship in the aforementioned step 1140, and specific descriptions may be found in FIG. 11 and the related descriptions thereof.

Subsequently, for each risk characteristic element combination in the accident vector corresponding to the historical accident, the processor may determine a second correlation parameter between the risk characteristic element combination and the historical accident that the accident vector corresponds to.

The second correlation parameter is a parameter representing a correlation relationship between each risk characteristic element (when it is included in the risk characteristic element combination) and a corresponding accident characteristic element of the accident vector corresponding to the historical accident. In some embodiments, the processor may determine the first relationship of the risk characteristic element combination when it includes the risk characteristic element according to the method of determining the correlation relationship in the aforementioned step 1350; then determine the second relationship of the risk characteristic element or combination when the risk characteristic element combination does not include the risk characteristic element according to the method of determining the correlation relationship in the aforementioned step 1140 or the aforementioned step 1350 (it is understandable that if the combination includes only two risk characteristic elements, after removing the risk characteristic element, only one risk characteristic element remains, and the second relationship may be calculated using the method in step 1140; if the combination includes three or more risk characteristic elements, after removing the risk characteristic element, a risk characteristic element combination still remains, and the second relationship still needs to be calculated using the method in step 1350); and take a difference obtained by subtracting the second relationship from the first relationship as the second correlation parameter. Exemplarily, a correlation relationship between risk characteristic element combination 1 (risk characteristic element 1, risk characteristic element 2) and historical accident 1 is 70%, and a correlation relationship between risk characteristic element 2 and historical accident 1 is 20%; then when risk characteristic element 1 is included in risk characteristic element combination 1, a second correlation parameter of risk characteristic element 1 for historical accident 1 is 50%. As another example, a correlation relationship between risk characteristic element combination 2 (risk characteristic element 1, risk characteristic element 5, risk characteristic element 8) and historical accident 1 is 60%, and a correlation relationship between risk characteristic element combination 3 (risk characteristic element 5, risk characteristic element 8) and historical accident 1 is 40%; then when risk characteristic element 1 is included in risk characteristic element combination 2, a second correlation parameter of risk characteristic element 1 for historical accident 1 is 20%. It is understandable that the risk characteristic element may appear in a plurality of risk characteristic element combinations, so the calculated second correlation parameters may also be a plurality.

Finally, the processor may determine the contribution parameter of each risk characteristic element to the historical accident based on the first correlation parameter and the second correlation parameter.

In some embodiments, the processor may determine a target weight; and determine the contribution parameter of each risk characteristic element to the historical accident based on the first correlation parameter, the second correlation parameter, and the target weight. For example, the processor may add a sum of products of each second correlation parameter of the risk characteristic element and its corresponding target weight to the first correlation parameter to determine the contribution parameter of the risk characteristic element to the historical accident, i.e., contribution parameter=first correlation parameter+second correlation parameter 1*target weight 1 of risk characteristic element combination 1+ . . . + second correlation parameter n*target weight n of risk characteristic element combination n. The target weight refers to a contribution weight of an included risk characteristic element relative to the risk characteristic element combination. In some embodiments, the target weight may be related to at least one of a count of elements in the accident vector, a count of elements in the risk characteristic element combination, a determination time of the risk characteristic element, or an inherent weight of the risk characteristic element. For example, the target weight may be related to the count of elements in the accident vector and the count of elements in the risk characteristic element combination. Exemplarily, the target weight may be calculated based on a preset formula. For example, the preset formula may be:

Target weight=[(the count of elements in the risk characteristic element combination−1)!×(the count of elements in the accident vector−the count of elements in the risk characteristic element combination)!)]/(the count of elements in the accident vector)!),

where the count of elements refers to the count of risk characteristic elements.

It is understandable that the target weight is intended to represent a value improvement of the entire risk characteristic element combination after adding a certain risk characteristic element. Therefore, when setting the preset formula for the target weight, it is necessary to first consider the possible combination of other risk characteristic elements in the risk characteristic element combination except for the risk characteristic element, and then add the risk characteristic element. For example, the numerator in the aforementioned preset formula is (a count of permutations and combinations of other risk characteristic elements in the risk characteristic element combination except the risk characteristic element when order is considered)*(a count of permutations and combinations of placing the risk characteristic element as the last element, which is omitted in the formula because there is only 1 type)*(a count of permutations and combinations of elements in the accident vector that are not in the risk characteristic element combination when considering the order), and the denominator is (a count of permutations and combinations of all elements in the accident vector when order is considered). As another example, the target weight may be related to the determination time of the risk characteristic element. The closer the determination time of the risk characteristic element is to the current time, the larger the target weight is set. As a further example, the target weight may be related to the inherent weight of the risk characteristic element. The larger the inherent weight of the risk characteristic element, the larger the target weight is set. The inherent weight of the risk characteristic element may be set based on experience or requirements. For example, the inherent weight of the risk characteristic element may be related to the correlation relationship between the risk characteristic element and the corresponding accident characteristic element, and the larger the correlation relationship, the higher the inherent weight of the risk characteristic element. The processor may traverse each risk characteristic element based on the aforementioned method to determine the contribution parameter of each risk characteristic element to the historical accident.

It is understandable that there are numerous possible permutations and combinations of risk characteristic element combinations, and the gain effect of a risk characteristic element in each combination varies. If each second correlation parameter is simply and crudely equally weighted, the obtained contribution parameters will undoubtedly have large deviations. In the embodiments of the present disclosure, the contribution parameter is determined based on the first correlation parameter, the second correlation parameter, and the target weight, and the target weight is set to be related to at least one of the count of elements in the accident vector, the count of elements in the risk characteristic element combination, the determination time of the risk characteristic element, and the inherent weight of the risk characteristic element. This can comprehensively consider the possibility of all risk characteristic element combinations, and determine the most accurate possible weight allocation according to various parameters such as the scale of various combinations, the contribution degree of elements under each combination, and the importance of elements themselves, thereby helping to improve the accuracy and reliability of the contribution parameter.

In the embodiments of the present disclosure, for each risk characteristic element, by determining the first correlation parameter between each risk characteristic element and the historical accident; for each risk characteristic element combination in the accident vector corresponding to the historical accident, determining the second correlation parameter between the risk characteristic element combination and the corresponding historical accident; and determining the contribution parameter of each risk characteristic element to the historical accident based on the first correlation parameter and the second correlation parameter, and based on the correlation between the risk characteristic element and the accident, the impact of the risk characteristic element when included in the combination on the accident, and the total impact of the element can be comprehensively determined, making the calculation of the risk characteristic impact parameter more reasonable.

Step 1420, determining a key risk characteristic element of the historical accident based on the plurality of risk characteristic elements and the corresponding contribution parameters. More descriptions of the key risk characteristic element may be found in FIGS. 8A-8B and the related descriptions thereof.

In some embodiments, the processor may compare the contribution parameters of the risk characteristic elements and determine a risk characteristic element with the maximum contribution parameter as the key risk characteristic element of the historical accident.

In some embodiments, the processor may determine whether the contribution parameter of each risk characteristic element to the historical accident meets a first preset condition.

The first preset condition refers to a condition for screening key risk characteristic elements based on the contribution parameter. The first preset condition may be set based on experience or requirements. Exemplarily, the first preset condition may be screening risk characteristic elements whose contribution parameter exceeds a contribution parameter threshold. The contribution parameter threshold may be set based on experience or requirements. The first preset condition may also be sorting the risk characteristic elements in descending order of contribution parameters and screening the top x % of risk characteristic elements by contribution parameter, or the like.

In response to determining that the contribution parameter meets the first preset condition, the processor may determine the risk characteristic element as the key risk characteristic element.

In the embodiments of the present disclosure, by determining whether the contribution parameter of each risk characteristic element to the historical accident meets the first preset condition; and in response to determining that the contribution parameter meets the first preset condition, determining the risk characteristic element as the key risk characteristic element, the key risk characteristic elements with larger contribution parameters can be accurately identified, facilitating timely rectification and avoiding safety risk accidents.

In the embodiments of the present disclosure, for each risk characteristic element in an accident vector corresponding to each historical accident, by determining the contribution parameter of the risk characteristic element to the historical accident; and determining the key risk characteristic element of the historical accident based on risk characteristic elements and the corresponding contribution parameters, the risk characteristic element having a greater impact on the safety accident can be determined as the key characteristic element. Compared with simple judgment based on the correlation relationship, the key characteristic element obtained by this method is more reasonable.

One or more embodiments of the present disclosure provide a method for engineering safety risk management. In some embodiments, the engineering safety risk management method may be performed by an engineering safety risk management system 1600 and its modules. The method includes obtaining historical construction data, wherein the historical construction data includes a plurality of completed historical minimum production units and quality and safety events corresponding to each of the plurality of completed historical minimum production units; determining, based on the historical construction data, first risk correlation information between a plurality of internal attributes of the each of the plurality of the completed historical minimum production units as well as a combination of the plurality of internal attributes, and the quality and safety events; determining a plurality of current minimum production units of a current construction project and current internal attributes of each of the plurality of current minimum production units; and determining, based on the current internal attributes and the first risk correlation information, one or more risk points of the plurality of current minimum production units and a risk probability corresponding to each of the one or more risk points, wherein the each of the one or more risk points corresponds to one quality and safety event (also referred to as an accident; it is understandable that a quality and safety event when it has occurred may be regarded as a historical accident).

In some embodiments, a processor may determine a first set and a second set, the first set consisting of one or more completed historical minimum production units to which the plurality of internal attributes belong, the second set consisting of one or more completed historical minimum production units to which the combination of the plurality of internal attributes belongs; determine historical quality and safety events corresponding to all completed historical minimum production units in the first set and the second set; and determine the first risk correlation information based on a count of completed historical minimum production units in the first set and a count of quality and safety events in the first set, as well as a count of completed historical minimum production units in the second set and a count of quality and safety events in the second set.

In some embodiments, the processor may determine the one or more risk points and a plurality of sub-risk probabilities of the each of the one or more risk points based on the current internal attributes, a combination of the current internal attributes, and the first risk correlation information; and determine the risk probability corresponding to the each of the one or more risk points based on the plurality of sub-risk probabilities of the each of the one or more risk points.

In some embodiments, the processor may determine, based on the historical construction data, second risk correlation information between a plurality of external attributes of the each of the plurality of completed historical minimum production units as well as a combination of the plurality of external attributes, and the quality and safety events, the plurality of external attributes at least including an inspection attribute; in response to determining that a current minimum production unit of the current construction project is under construction, obtain current external attributed of the current minimum production unit; and determine one or more risk points of the current minimum production unit and a risk probability corresponding to each of the one or more risk points of the current minimum production unit based on the current internal attributes of the current minimum production unit, the current external attributes, the first risk correlation information, and the second risk correlation information.

In some embodiments, the processor may obtain a hazard degree of the each of the one or more risk points and determine a risk level of the each of the one or more risk points based on the risk probability and the hazard degree.

In some embodiments, the processor may obtain a general layout drawing, a building outline, and a count of building floors of the current construction project; determine a model framework based on the general layout drawing; determine a local display area based on the building outline; generate a project display model based on the model framework, the local display area, and the count of building floors, the project display model including a plurality of local display areas; obtain spatial information of a current minimum production unit, and generating a risk display icon in the local display area based on the spatial information and the risk level.

In some embodiments, the spatial information includes drawing information, and in response to determining that a construction drawing is updated, the processor may determine change information of a component of the updated construction drawing; and adjust the risk display icon in the local display area based on the change information.

More descriptions of the engineering safety risk management method may be found in the related descriptions of FIG. 1 to FIG. 14.

One or more embodiments of the present disclosure provide an engineering safety risk management method. In some embodiments, the method may be performed by an engineering safety risk management system 1700 and its modules. The method includes determining a target vector based on on-site engineering collected data, the target vector at least including an on-site engineering characteristic element and an on-site risk characteristic element; and determining warning information related to an engineering safety risk based on the target vector and a safety risk model, and sending the warning information to a user.

In some embodiments, the processor may determine risk characteristic data of functional domains under a plurality of safety risk control types based on a safety responsibility list, the risk characteristic data corresponding to a potential hazard; obtain historical accident data of a plurality of historical accidents; determine a plurality of accident vectors corresponding to the plurality of historical accidents based on the historical accident data and the risk characteristic data, the plurality of accident vectors at least including an engineering characteristic element, a risk characteristic element, and an accident characteristic element; construct an accident vector library based on the plurality of accident vectors; divide the accident vector library into a plurality of sub-vector libraries based on the engineering characteristic element; for each of the plurality of sub-vector libraries: determine correlation relationships between a plurality of risk characteristic elements and a plurality of accident characteristic elements in the sub-vector library; determine, based on the correlation relationships, risk levels corresponding to the plurality of risk characteristic elements and the plurality of accident characteristic elements in the sub-vector library; and construct the safety risk model based on the plurality of risk characteristic elements, the plurality of accident characteristic elements in the sub-vector library, the correlation relationships, and the risk levels.

In some embodiments, the processor may determine a risk characteristic tree based on the safety responsibility list, the risk characteristic tree including at least three layers, wherein a first layer of the at least three layers includes the plurality of safety risk control types, a second layer of the at least three layers includes functional domains included in each of the plurality of safety risk control types, and a third layer of the at least three layers includes the risk characteristic data corresponding to each of the functional domains, the risk characteristic data corresponding to each of the functional domains at least including a risk characteristic value and a value-taking condition corresponding to the risk characteristic value.

In some embodiments, for each of the plurality of risk characteristic elements and each of the plurality of accident characteristic elements in the sub-vector library, the processor may determine a risk characteristic value corresponding to the risk characteristic element and an accident characteristic value corresponding to the accident characteristic element; determine a first classification result by classifying accident vectors in the sub-vector library based on the risk characteristic value; determine a second classification result by classifying the accident vectors in the sub-vector library based on the accident characteristic value; and determine a correlation relationship between the risk characteristic element and the accident characteristic element based on the first classification result and the second classification result.

In some embodiments, the processor may form a risk characteristic element combination by selecting a preset count of risk characteristic elements from the plurality of risk characteristic elements in the sub-vector library, and determining a risk characteristic value combination corresponding to the risk characteristic element combination; for each of the plurality of accident characteristic elements in the sub-vector library, determine an accident characteristic value corresponding to the accident characteristic element; determine a third classification result by classifying the accident vector in the sub-vector library based on the risk characteristic value combination; determine a fourth classification result by classifying the accident vector in the sub-vector library based on the accident characteristic value; and determine a correlation relationship between the risk characteristic element combination and the accident characteristic element based on the third classification result and the fourth classification result.

In some embodiments, the processor may, for each risk characteristic element in an accident vector corresponding to each of the plurality of historical accidents, determine a contribution parameter of the risk characteristic element to the historical accident; and determine a key risk characteristic element of the historical accident based on the plurality of risk characteristic elements and the corresponding contribution parameters.

In some embodiments, the processor may determine a first correlation parameter between the risk characteristic element and the historical accident, the first correlation parameter being a parameter representing a correlation relationship between the risk characteristic element and a corresponding accident characteristic element of the accident vector corresponding to the historical accident; for each risk characteristic element combination in the accident vector corresponding to the historical accident, determine a second correlation parameter between the risk characteristic element combination and the historical accident, the second correlation parameter being a parameter representing a correlation relationship, when the risk characteristic element is in the risk characteristic element combination, between the risk characteristic element and a corresponding accident characteristic element of the accident vector corresponding to the historical accident; and determine the contribution parameter of the risk characteristic element to the historical accident based on the first correlation parameter and the second correlation parameter.

In some embodiments, the processor may determine a target weight, wherein the target weight is related to at least one of a count of elements in the accident vector, a count of elements in the risk characteristic element combination, a determination time of the risk characteristic element, or an inherent weight of the risk characteristic element; and determine the contribution parameter of the risk characteristic element to the historical accident based on the first correlation parameter, the second correlation parameter, and the target weight.

In some embodiments, the processor may determine whether the contribution parameter of the risk characteristic element to the historical accident meets a first preset condition; and in response to determining that the contribution parameter meets the first preset condition, determine the risk characteristic element as the key risk characteristic element.

In some embodiments, the processor may determine the safety risk model based on the on-site engineering characteristic element in the target vector; query the safety risk model based on the on-site risk characteristic element in the target vector to determine a target accident characteristic element whose correlation relationship with the on-site risk characteristic element meets a second preset condition and a risk level corresponding to the target accident characteristic element; and determine the warning information based on the target accident characteristic element, the risk level, and warning rule, and sending the warning information to the user.

In some embodiments, the processor may determine the safety risk model based on the on-site engineering characteristic element in the target vector; query the safety risk model based on the target vector to determine a key risk characteristic element of the accident; and determine the warning information based on the key risk characteristic element and the warning rule, and sending the warning information to the user.

More descriptions of the engineering safety risk management method may be found in the related descriptions of FIG. 1 to FIG. 14.

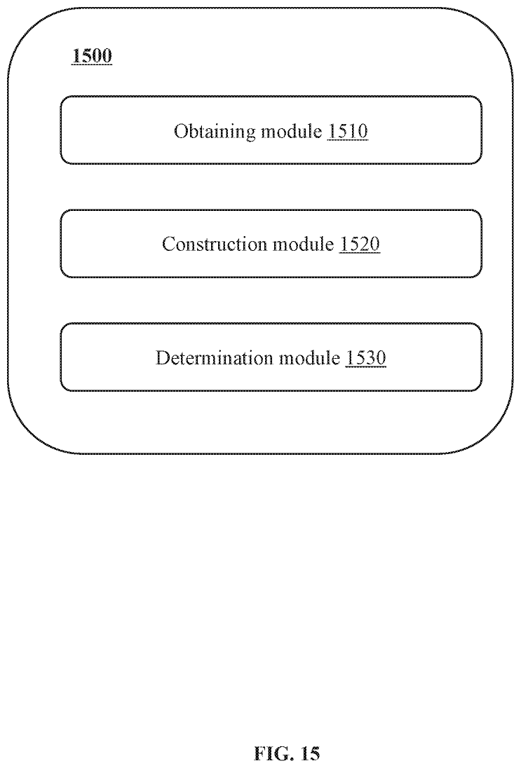

FIG. 15 is a block diagram illustrating an exemplary engineering safety risk management system according to some embodiments of the present disclosure. In some embodiments, the engineering safety risk management system 1500 may include an obtaining module 1510, a construction module 1520, and a determination module 1530. In some embodiments, each module in the engineering safety risk management system 1500 may be implemented by the server 120 (e.g., a processor in the server 120).

In some embodiments, the obtaining module 1510 may be configured to obtain historical construction data. More descriptions of how to obtain the historical construction data may be found in the related description of step 210.

In some embodiments, the construction module 1520 may be configured to construct a safety risk database based on the historical construction data. More descriptions of how to construct the safety risk database may be found in the related description of step 220.

In some embodiments, the determination module 1530 may be configured to determine safety risk data of the current construction project based on data collected from the current construction project and the safety risk database. More descriptions of how to determine the safety risk data may be found in the related description of step 230.

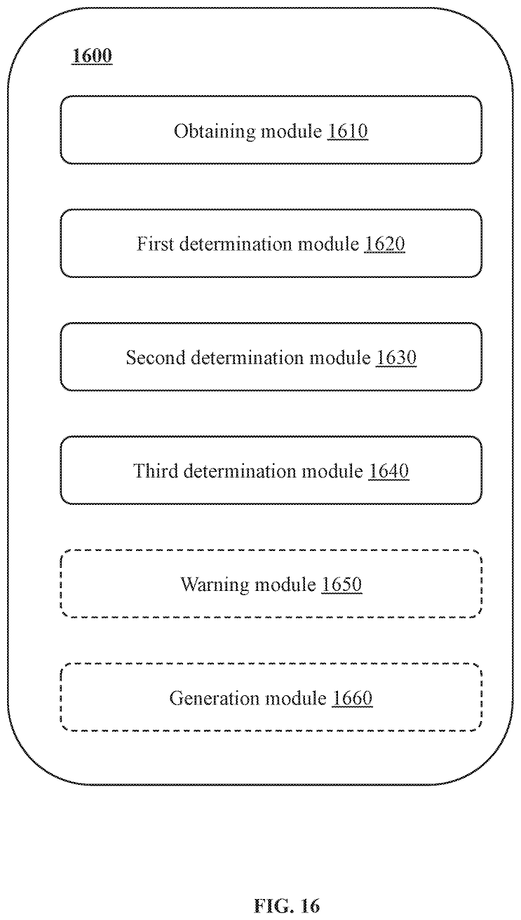

FIG. 16 is a block diagram illustrating an exemplary engineering safety risk management system according to some embodiments of the present disclosure. In some embodiments, the engineering safety risk management system 1600 may include an obtaining module 1610, a first determination module 1620, a second determination module 1630, and a third determination module 1640. In some embodiments, each module in the engineering safety risk management system 1600 may be implemented by the server 120 (e.g., a processor in the server 120).

In some embodiments, the obtaining module 1610 may be configured to obtain historical construction data. More descriptions of how to obtain the historical construction data may be found in the related description of step 210.

In some embodiments, the first determination module 1620 may be configured to determine, based on the historical construction data, first risk correlation information between a plurality of internal attributes of the each of the plurality of the completed historical minimum production units as well as a combination of the plurality of internal attributes, and the quality and safety events. More descriptions of how to obtain the internal attributes and the first risk correlation information may be found in the related description of step 310.

In some embodiments, the second determination module 1630 may be configured to determine a plurality of current minimum production units of a current construction project and current internal attributes of each of the plurality of current minimum production units. More descriptions of how to determine the current minimum production units and the current internal attributes thereof may be found in FIG. 3 and the related descriptions thereof.

In some embodiments, the third determination module 1640 may be configured to determine, based on the current internal attributes and the first risk correlation information, one or more risk points of the plurality of current minimum production units and a risk probability corresponding to each of the one or more risk points. In some embodiments, the third determination module 1640 may be further configured to determine the one or more risk points and a plurality of sub-risk probabilities of the each of the one or more risk points based on the current internal attributes, a combination of the current internal attributes and the first risk correlation information; and obtain the risk probability corresponding to the each of the one or more risk points based on the plurality of sub-risk probabilities of the each of the one or more risk points. More descriptions of how to determine the risk probability may be found in FIG. 3 and the related descriptions thereof.

In some embodiments, the engineering safety risk management system 1600 may further include a warning module 1650 and a generation module 1660.

In some embodiments, the warning module 1650 may be configured to obtain a hazard degree of the each of the one or more risk points, and determine a risk level of the each of the one or more risk points based on the risk probability and the hazard degree. More descriptions of how to determine the risk level may be found in FIG. 3 and the related descriptions thereof. In some embodiments, the warning module 1650 may be further configured to issue a warning based on the risk level.

In some embodiments, the generation module 1660 may be configured to obtain a general layout drawing, a building outline, and a count of building floors of the current construction project; determine a model framework based on the general layout drawing; determine a local display area based on the building outline; generate a project display model based on the model framework, the local display area, and the count of building floors, the project display model including a plurality of local display areas; obtain spatial information of a current minimum production unit, and generating a risk display icon in the local display area based on the spatial information and the risk level. More descriptions of how to generate the risk display icon may be found in FIG. 5 and the related descriptions thereof.

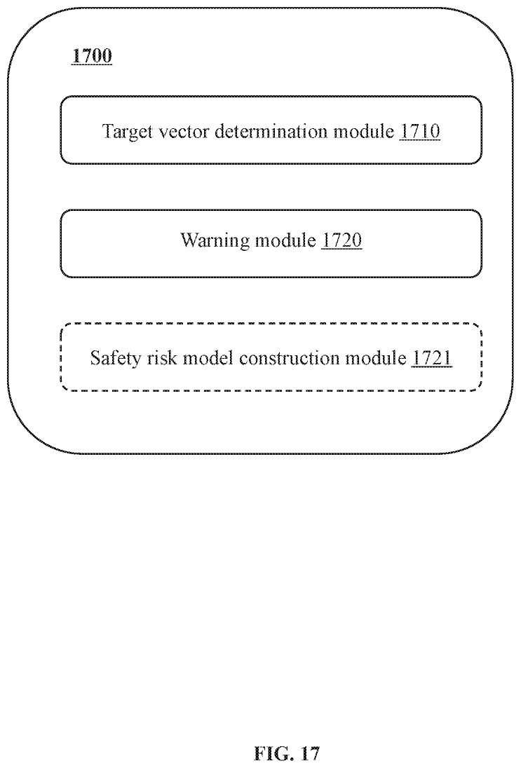

FIG. 17 is a block diagram illustrating an exemplary engineering safety risk management system according to some embodiments of the present disclosure. In some embodiments, the engineering safety risk management system 1700 may include a target vector determination module 1710 and a warning module 1720. In some embodiments, each module in the engineering safety risk management system 1700 may be implemented by the server 120 (e.g., a processor in the server 120).

In some embodiments, the target vector determination module 1710 may be configured to determine a target vector based on the on-site engineering collected data. More descriptions of how to determine the target vector may be found in the related description of step 810.

In some embodiments, the warning module 1720 may determine warning information related to an engineering safety risk based on the target vector and a safety risk model, and send the warning information to a user. More descriptions of how to determine the warning information may be found in the related description of step 820.

In some embodiments, the warning module 1720 may include a safety risk model construction module 1721. In some embodiments, the safety risk model construction module 1721 may determine risk characteristic data of functional domains under a plurality of safety risk control types based on a safety responsibility list, the risk characteristic data corresponding to a potential hazard; obtain historical accident data of a plurality of historical accidents; determine a plurality of accident vectors corresponding to the plurality of historical accidents based on the historical accident data and the risk characteristic data, the plurality of accident vectors at least including an engineering characteristic element, a risk characteristic element, and an accident characteristic element; construct an accident vector library based on the plurality of accident vectors; divide the accident vector library into a plurality of sub-vector libraries based on the engineering characteristic element; for each of the plurality of sub-vector libraries: determine correlation relationships between a plurality of risk characteristic elements and a plurality of accident characteristic elements in the sub-vector library; determine, based on the correlation relationships, risk levels corresponding to the plurality of risk characteristic elements and the plurality of accident characteristic elements in the sub-vector library; and construct the safety risk model based on the plurality of risk characteristic elements, the plurality of accident characteristic elements in the sub-vector library, the correlation relationships, and the risk levels. More descriptions of how to construct the safety risk model may be found in the related descriptions of steps 831 to 8354.

In some embodiments, two or more modules in the engineering safety risk management systems 1500-1700 may be combined into one module, which may implement the functions of the two or more modules. For example, the obtaining module 1510 and the construction module 1520 may be combined into one module, which may be configured to obtain historical construction data and construct the safety risk database. As another example, the first determination module 1620, the second determination module 1630, and the third determination module 1640 may be combined into one module, which may be configured to determine the completed historical minimum production units and their internal attributes, the current minimum production units and their current internal attributes, the risk points, and the risk probabilities corresponding to the risk points. As a further example, the warning module 1720 and the safety risk model construction module 1721 may be combined into one module, which may be configured to construct the safety risk model and determine the warning information. In some embodiments, one or more modules in the engineering safety risk management systems 1500-1700 may be omitted, or one or more new modules may be added to the engineering safety risk management systems 1500-1700.

One or more embodiments of the present disclosure provide a computer-readable storage medium. The storage medium stores computer instructions, and when a computer reads the computer instructions in the storage medium, the computer executes the engineering safety risk management method described in the embodiments of the present disclosure.

The basic concepts have been described above. It is clear to those skilled in the art that the foregoing detailed disclosure is merely exemplary and does not constitute a limitation on the present specification. Although not explicitly stated herein, those skilled in the art may make various modifications, improvements, and amendments to the present specification. Such modifications, improvements, and amendments are suggested in the present specification, and thus still fall within the spirit and scope of the exemplary embodiments of the present specification.

Meanwhile, specific terms are used in the present specification to describe the embodiments thereof. For example, “one embodiment”, “an embodiment”, and/or “some embodiments” mean a certain feature, structure, or characteristic associated with at least one embodiment of the present specification. Therefore, it should be emphasized and noted that references to “an embodiment”, “one embodiment” or “an alternative embodiment” in different places in the present specification, two or more times, do not necessarily refer to the same embodiment. Furthermore, certain features, structures, or characteristics of one or more embodiments of the present specification may be suitably combined.

Furthermore, unless explicitly stated in the claims, the order of processing elements and sequences, the use of numerals and letters, or other designations described in the present specification are not intended to limit the order of the processes and methods of the present specification. While the foregoing disclosure discusses, through various examples, some inventive embodiments that are presently considered useful, it should be understood that such details are for illustrative purposes only, and the appended claims are not limited to the disclosed embodiments. On the contrary, the claims are intended to cover all modifications and equivalent combinations that conform to the spirit and scope of the embodiments of the present specification. For example, although the system components described above may be implemented by hardware devices, they may also be implemented solely by software solutions, such as installing the described system on an existing server or mobile device.

By the same token, it should be noted that in the foregoing description of the embodiments of the present specification, various features are sometimes grouped together in a single embodiment, figure, or description thereof for the purpose of simplifying the disclosure of the present specification and thereby facilitating the understanding of one or more inventive embodiments. However, such a method of disclosure does not imply that the subject matter of the present specification requires more features than those recited in the claims. In fact, an embodiment has fewer features than all the features of a single embodiment disclosed above.

Numerical values describing quantities of components or attributes are used in some embodiments. It should be understood that such numerical values used in describing the embodiments are modified by the modifiers “about”, “approximately”, or “substantially” in some instances. Unless otherwise stated, “about”, “approximately” or “substantially” indicates that the stated numerical value allows for a variation of ±20%. Accordingly, in some embodiments, the numerical parameters used in the specification and claims are approximate values, which may vary according to the desired characteristics of individual embodiments. In some embodiments, numerical parameters shall take into account the specified significant digits and adopt general rounding methods. Although the numerical ranges and parameters used to confirm the breadth of the scope in some embodiments of the present specification are approximate values, in specific embodiments, such numerical values are set as precisely as practicable.

Each patent, patent application, patent application publication, and other material cited in the present specification, such as articles, books, manuals, publications, documents, and the like, is hereby incorporated herein by reference in its entirety. Excluded are application history documents that are inconsistent with or conflict with the content of the present specification, as well as documents (currently or hereafter appended to the present specification) that limit the broadest scope of the claims of the present specification. It should be noted that if there is any inconsistency or conflict between the descriptions, definitions, and/or usage of terms in the accompanying materials of the present specification and the content set forth in the present specification, the descriptions, definitions, and/or usage of terms in the present specification shall prevail.

Finally, it should be understood that the embodiments described in the present specification are merely illustrative of the principles of the embodiments of the present specification. Other variations may also fall within the scope of the present specification. Accordingly, alternative configurations of the embodiments of the present specification may be considered consistent with the teachings of the present specification, by way of example and not limitation. Consequently, the embodiments of the present specification are not limited to those expressly introduced and described herein.

What is claimed is:

1. A method for engineering safety risk management, comprising:
obtaining historical construction data, wherein the historical construction data includes a plurality of completed historical minimum production units and data related to historical accidents corresponding to each of the plurality of completed historical minimum production units;
constructing a safety risk database based on the historical construction data; and
determining safety risk data of a current construction project based on data collected from the current construction project and the safety risk database.

2. The method of claim 1, wherein the constructing a safety risk database based on the historical construction data includes:
determining, based on the historical construction data, first risk correlation information between a plurality of internal attributes of the each of the plurality of completed historical minimum production units as well as a combination of the plurality of internal attributes, and the historical accidents, the plurality of internal attributes including at least one of a task item attribute, a personnel attribute, or a regional attribute; and
constructing the safety risk database based on the plurality of completed historical minimum production units, the plurality of internal attributes, the historical accidents, and the first risk correlation information.

3. The method of claim 2, wherein the determining, based on the historical construction data, first risk correlation information between a plurality of internal attributes of the each of the plurality of completed historical minimum production units as well as a combination of the plurality of internal attributes, and the historical accidents includes:
determining a first set and a second set, the first set consisting of one or more completed historical minimum production units to which the plurality of internal attributes belong, the second set consisting of one or more completed historical minimum production units to which the combination of the plurality of internal attributes belongs;
determining historical accidents corresponding to all completed historical minimum production units in the first set and the second set; and
determining the first risk correlation information based on a count of completed historical minimum production units in the first set and a count of historical accidents in the first set, as well as a count of completed historical minimum production units in the second set and a count of historical accidents in the second set.

4. The method of claim 2, wherein the determining safety risk data of a current construction project based on data collected from the current construction project and the safety risk database includes:
determining, based on the data collected from the current construction project, a plurality of current minimum production units of the current construction project and current internal attributes of each of the plurality of current minimum production units; and
determining, based on the current internal attributes and the first risk correlation information, one or more risk points of the plurality of current minimum production units and a risk probability corresponding to each of the one or more risk points.

5. The method of claim 2, further comprising:
determining, based on the historical construction data, second risk correlation information between a plurality of external attributes of the each of the plurality of completed historical minimum production units as well as a combination of the plurality of external attributes, and the historical accidents, the plurality of external attributes at least including an inspection attribute; and
constructing the safety risk database based on the plurality of completed historical minimum production units, the plurality of internal attributes, the plurality of external attributes, the historical accidents, the first risk correlation information, and the second risk correlation information.

6. The method of claim 5, further comprising:
in response to determining that a current minimum production unit of the current construction project is under construction, obtaining current external attributes of the current minimum production unit; and
determining one or more risk points of the current minimum production unit and a risk probability corresponding to each of the one or more risk points of the current minimum production unit based on current internal attributes of the current minimum production unit, the current external attributes, the first risk correlation information, and the second risk correlation information.

7. The method of claim 4, further comprising:
obtaining a hazard degree of the each of the one or more risk points; and
determining a risk level of the each of the one or more risk points based on the risk probability and the hazard degree.

8. The method of claim 7, further comprising:
obtaining a general layout drawing, a building outline, and a count of building floors of the current construction project;
determining a model framework based on the general layout drawing;
determining a local display area based on the building outline;
generating a project display model based on the model framework, the local display area, and the count of building floors, the project display model including a plurality of local display areas; and
obtaining spatial information of a current minimum production unit, and generating a risk display icon in the local display area based on the spatial information and the risk level.

9. The method of claim 8, wherein the spatial information at least includes drawing information, the method further including:
in response to determining that a construction drawing is updated, determining change information of a component of the updated construction drawing; and
adjusting the risk display icon in the local display area based on the change information.

10. The method of claim 1, wherein the constructing a safety risk database based on the historical construction data includes:
determining risk characteristic data of functional domains under a plurality of safety risk control types based on a safety responsibility list, the risk characteristic data corresponding to a potential hazard;
determining a plurality of accident vectors corresponding to the historical accidents based on data related to the historical accidents and the risk characteristic data, the plurality of accident vectors at least including an engineering characteristic element, a risk characteristic element, and an accident characteristic element;
constructing an accident vector library based on the plurality of accident vectors;
dividing the accident vector library into a plurality of sub-vector libraries based on the engineering characteristic element;
for each of the plurality of sub-vector libraries,
determining correlation relationships between a plurality of risk characteristic elements and a plurality of accident characteristic elements in the sub-vector library;
determining, based on the correlation relationships, risk levels corresponding to the plurality of risk characteristic elements and the plurality of accident characteristic elements in the sub-vector library;
constructing a safety risk model based on the plurality of risk characteristic elements and the plurality of accident characteristic elements in the sub-vector library, the correlation relationships, and the risk levels; and
constructing the safety risk database based on the safety risk model.

11. The method of claim 10, wherein the determining correlation relationships between a plurality of risk characteristic elements and a plurality of accident characteristic elements in the sub-vector library includes:
for each of the plurality of risk characteristic elements and each of the plurality of accident characteristic elements in the sub-vector library,
determining a risk characteristic value corresponding to the risk characteristic element and an accident characteristic value corresponding to the accident characteristic element;
determining a first classification result by classifying accident vectors in the sub-vector library based on the risk characteristic value;
determining a second classification result by classifying the accident vectors in the sub-vector library based on the accident characteristic value; and
determining a correlation relationship between the risk characteristic element and the accident characteristic element based on the first classification result and the second classification result.

12. The method of claim 10, wherein the determining correlation relationships between a plurality of risk characteristic elements and a plurality of accident characteristic elements in the sub-vector library includes:
forming a risk characteristic element combination by selecting a preset count of risk characteristic elements from the plurality of risk characteristic elements in the sub-vector library, and determining a risk characteristic value combination corresponding to the risk characteristic element combination;
for each of the plurality of accident characteristic elements in the sub-vector library, determining an accident characteristic value corresponding to the accident characteristic element;
determining a third classification result by classifying accident vectors in the sub-vector library based on the risk characteristic value combination;
determining a fourth classification result by classifying the accident vectors in the sub-vector library based on the accident characteristic value; and
determining a correlation relationship between the risk characteristic element combination and the accident characteristic element based on the third classification result and the fourth classification result.

13. The method of claim 10, wherein the constructing a safety risk model includes:
for each risk characteristic element in an accident vector corresponding to each of the historical accidents, determining a contribution parameter of the risk characteristic element to the historical accident; and
determining a key risk characteristic element of the historical accident based on the plurality of risk characteristic elements and corresponding contribution parameters.

14. The method of claim 13, wherein the determining a contribution parameter of the risk characteristic element to the historical accident includes:
determining a first correlation parameter between the risk characteristic element and the historical accident, the first correlation parameter being a parameter representing a correlation relationship between the risk characteristic element and a corresponding accident characteristic element of the accident vector corresponding to the historical accident;
for each risk characteristic element combination in the accident vector corresponding to the historical accident, determining a second correlation parameter between the risk characteristic element combination and the historical accident, the second correlation parameter being a parameter representing a correlation relationship, when the risk characteristic element is in the risk characteristic element combination, between the risk characteristic element and a corresponding accident characteristic element of the accident vector corresponding to the historical accident; and
determining the contribution parameter of the risk characteristic element to the historical accident based on the first correlation parameter and the second correlation parameter.

15. The method of claim 14, wherein the determining the contribution parameter of the risk characteristic element to the historical accident based on the first correlation parameter and the second correlation parameter includes:
determining a target weight, wherein the target weight is related to at least one of a count of elements in the accident vector, a count of elements in the risk characteristic element combination, a determination time of the risk characteristic element, or an inherent weight of the risk characteristic element; and
determining the contribution parameter of the risk characteristic element to the historical accident based on the first correlation parameter, the second correlation parameter, and the target weight.

16. The method of claim 14, wherein the determining a key risk characteristic element of the historical accident includes:
determining whether the contribution parameter of the risk characteristic element to the historical accident meets a first preset condition; and
in response to determining that the contribution parameter meets the first preset condition, determining the risk characteristic element as the key risk characteristic element.

17. The method of claim 10, wherein the determining safety risk data of a current construction project based on data collected from the current construction project and the safety risk database includes:
determining a target vector based on the data collected from the current construction project, the target vector at least including an on-site engineering characteristic element and an on-site risk characteristic element; and
determining the safety risk data of the current construction project based on the target vector and the safety risk model.

18. The method of claim 17, wherein
the determining the safety risk data of the current construction project based on the target vector and the safety risk model includes:
determining the safety risk model based on the on-site engineering characteristic element in the target vector;
querying the safety risk model based on the on-site risk characteristic element in the target vector to determine a target accident characteristic element whose correlation relationship with the on-site risk characteristic element meets a second preset condition and a risk level corresponding to the target accident characteristic element; and
determining the safety risk data of the current construction project based on the target accident characteristic element, the risk level, and a warning rule, or
an accident occurs at the current construction project, the target vector further includes an on-site accident characteristic element, and the determining the safety risk data of the current construction project based on the target vector and the safety risk model includes:
determining the safety risk model based on the on-site engineering characteristic element in the target vector;
querying the safety risk model based on the target vector to determine a key risk characteristic element of the accident; and
determining the safety risk data of the current construction project based on the key risk characteristic element.

19. A method for engineering safety risk management, comprising:
obtaining historical construction data, wherein the historical construction data includes a plurality of completed historical minimum production units and quality and safety events corresponding to each of the plurality of completed historical minimum production units;
determining, based on the historical construction data, first risk correlation information between a plurality of internal attributes of the each of the plurality of the completed historical minimum production units as well as a combination of the plurality of internal attributes, and the quality and safety events, the plurality of internal attributes including at least one of a task item attribute, a personnel attribute, or a regional attribute;
determining a plurality of current minimum production units of a current construction project and current internal attributes of each of the plurality of current minimum production units; and
determining, based on the current internal attributes and the first risk correlation information, one or more risk points of the plurality of current minimum production units and a risk probability corresponding to each of the one or more risk points, wherein the each of the one or more risk points corresponds to one quality and safety event.

20. A method for engineering safety risk management, comprising:
determining a target vector based on on-site engineering collected data, the target vector at least including an on-site engineering characteristic element and an on-site risk characteristic element; and
determining warning information related to an engineering safety risk based on the target vector and a safety risk model, and sending the warning information to a user.
